(19) United States
(12) Patent Application Publication
(10) Pub. No.: US 2007/0243832 A1
(43) Pub. Date: Oct. 18, 2007

(54) Multimode/Multiband Mobile Station and Method for Operating the Same

(76) Inventors: Hyung-Weon Park, Seoul (KR); Woo-Yong Lee, Gyeonggi-do (KR); Young-Il Son, Gyeonggi-do (KR); Seong-Eun Kim, Gyeonggi-do (KR); Michael Brobston, Collin County, TX (US); Lup M. Loh, Collin County, TX (US)

Correspondence Address: THE FARRELL LAW FIRM, P.C., 333 EARLE OVINGTON BOULEVARD, SUITE 701, UNIONDALE, NY, 11553, US

(21) Appl. No.: 10/585,755

(22) PCT Filed: Mar. 15, 2005
(86) PCT No.: PCT/KR05/00743

§ 371 Date: Jun. 14, 2007

Related U.S. Application Data
(60) Provisional application No. 60/553,104, filed on Mar. 15, 2004.

(30) Foreign Application Priority Data
Dec. 7, 2004 (KR) 10-2004-0102477
Mar. 11, 2005 (KR) 10-2005-0020749
Mar. 14, 2005 (KR) 10-2005-0021196

(51) Int. Cl. H04B 1/38

(52) U.S. Cl. 455/73

(57) ABSTRACT

A multimode/multiband mobile station and a method for operating the same are provided. A transmission module transmits multimode/multiband signals through transmitters. A reception module receives radio signals for different services of the same frequency band among multimode/multiband signals through receivers for the same frequency band, and receives radio signals of different frequency bands among the multimode/multiband signals through receivers for the different frequency bands. As compared with the conventional mobile station, the multimode/multiband mobile station can reduce the number of receivers by making use of one receiver to receive radio signals for different services of the same frequency band. The multimode/multiband mobile station can use a duplexer of the conventional frequency division duplex (FDD) technique (e.g., wideband code division multiple access (WCDMA)) in a time division duplex (TDD) technique (e.g., Global System for Mobile Communication (GSM) 850 or Personal Communication Service (PCS) 1900).

### BACKGROUND OF THE INVENTION

1. Field of the Invention

The present invention relates generally to a wireless transceiver, and in particular, to a mobile station supporting multi-modes and multi-bands.

2. Description of the Related Art

Recently, various access standards used for wireless networks have been being developed (e.g., Global System for Mobile Communication (GSM), code division multiple access (CDMA), wideband CDMA (WCDMA), The Institute of Electrical and Electronics Engineers (IEEE)-801.16, etc.). However, a rapid increase of the wireless access standards results in inconvenience to mobile stations (or terminals), such as cell-phones, personal data assistant (PDA) devices and mobile laptop computers, and difficulty in manufacturing the mobile stations. In addition, subscribers' expectation on existing networks cannot be satisfied with mobile stations supporting only a few available standards.

To deal with this, mobile stations are transited to a Software-Defined Radio (SDR) architecture, thereby providing a single hardware platform for multiple wireless interface technology. Due to continuous development of semiconductor process technology, a mobile station (or wireless terminal) can be changed to a communication transceiving system having a specific standard or a specific purpose by performing software reconstruction of a signal processing function, which takes a high proportion in the operation of the mobile station, on a single hardware platform, thereby providing various wireless standards in one system. There are many types of software reconfigurable hardware, e.g., a fixed functional block having changeable parameters and a flexible interconnection function. The software reconfigurable hardware can be implemented using field programmable gate arrays (FPGAs).

For an SDR design, a board space, material costs, current consumption for battery persistency, and a low level of the number of components should be considered. In addition, expectation to obtain a capability of roaming between various standards requires an SDR receiver to perform a quicker search and handoff. However, in general, greater power is necessary for quicker processing. For conventional development of mobile stations, various types of hardware are necessary for satisfying various wireless standards. For a design of conventional receivers, a zero-intermediate-frequency (ZIF) architecture in which an entire receiver front end is implemented using analog elements is used.

In the conventional ZIF architecture, a direct type down converter uses a narrowband device unsuitable for broadband applications. Besides, for a receiver design, parts are digitalized at an intermediate frequency (IF).

Thus technology for mobile stations implemented by optimizing software reconfigurable hardware components in a receiver front end is necessary. In particular, a receiver in which the reconfigurable components can be used before conversion to a digital signal at an IF level is necessary.

In common, mobile communication services are provided in different communication service methods for countries (regions) over the world, using several frequency bands for each communication service method. For example, the mobile communication service methods are provided using the CDMA technique, the GSM technique and the WCDMA technique for the countries (regions), wherein the CDMA technique uses frequency bands of 800 MHz, 1800 MHz and 1900 MHz, the GSM technique uses frequency bands of 850 MHz, 900 MHz, 1800 MHz and 1900 MHz, and the WCDMA technique uses frequency bands of 850 MHz, 1900 MHz and 2000 MHz.

The conventional mobile stations are constructed to use signals of one or two frequency bands corresponding to desired communication services among the mobile communication services. As a result, each mobile station can use only one or two mobile communication services among the various mobile communication services in the countries over the world. Accordingly, when a subscriber goes to another region in which a different communication service is provided for a travel or a business trip, it is inconvenient since his/her own mobile station cannot be used.

Thus subscribers want a mobile station with which all kinds of mobile communication services of the countries over the world can be provided. Mobile station manufacturers are trying to produce mobile stations so that all kinds of mobile communication services of the countries over the world can be used through one mobile station in response to the request of the subscribers. To use all kinds of mobile communication services of the countries over the world and frequency bands for the services, a mobile station supporting multi-modes and multi-bands is required.

### SUMMARY OF THE INVENTION

An object of the present invention is to substantially solve at least the above problems and/or disadvantages and to provide at least the advantages below. Accordingly, an object of the present invention is to provide a multimode/multiband mobile station that can reduce entire power consumption of software-defined radio (SDR) processing components.

This object can be achieved using a near-zero intermediate frequency (NZIF) radio frequency (RF) receiver front end architecture in which a lower intermediate frequency (IF) can be obtained and a processing speed of a digital intermediate frequency (DIF) receiver component is not highly required. The NZIF RF receiver can provide a relatively low sampling rate at the IF and simultaneously maintain a digital signal processing (DSP) function at an IF level.

The object is achieved by realizing a design of a broadband image rejection (IR) mixer in an RF analog front end of the receiver to satisfy multiple frequency bands with lower power consumption. The object is achieved by developing technologies of operating the DIF component with a possibility of construction of a DIF filter and at the relatively low sampling rate and decreasing the power consumption.

Another object of the present invention is to provide a multimode/multiband mobile station that can be used in a wireless network operating based on various wireless interface standards.

A further object of the present invention is to provide a mobile station supporting multi-modes and multi-bands using a wireless transceiver for different services of the same frequency band in response to the different services of the same frequency band.

A further object of the present invention is to provide a mobile station supporting multi-modes and multi-bands using a wireless transceiver for different services of the same frequency band and simultaneously supporting diversity.

According to one aspect of the present invention, there is provided a multimode/multiband mobile station for wireless networks operating based on various wireless interface standards, the mobile station comprising: a plurality of low-noise amplifiers (LNAs), each matched to a selected frequency band; and a near-zero intermediate frequency (NZIF) broadband image rejection (IR) mixer for receiving an amplified radio frequency (RF) signal from one amplifier selected among the plurality of LNAs and generating a first analog intermediate frequency (IF) signal by down converting the amplified RF signal.

According to another aspect of the present invention, there is provided an operating method of a multimode/multiband mobile station for wireless networks operating based on various wireless interface standards, the method comprising the steps of: amplifying a receive radio frequency (RF) signal by selecting one of a plurality of low-noise amplifiers (LNAs) and matching each of the plurality of LNAs to a selected frequency band; and generating, by a near-zero intermediate frequency (NZIF) broadband image rejection (IR) mixer, a first analog intermediate frequency (IF) signal by down converting the RF signal amplified by the selected LNA.

According to another aspect of the present invention, there is provided a multimode/multiband mobile station comprising: a transmission module for transmitting multiple modes and multiple bands through transmitters; and a reception module for receiving signals corresponding to the same frequency bands among the multimode/multiband signal through combined receivers, which receive at least one radio signal of the same frequency band for different services together, and receiving signals not corresponding to the same frequency bands through receivers for different frequency bands.

According to another aspect of the present invention, there. is provided a multimode/multiband mobile station comprising: a switch module for performing a switching operation for selecting a mode and band to be received among multiple modes and multiple bands based on a predetermined control; receivers, each for receiving its own mode/band signal among multimode/multiband signals based on the switching operation; mixers, each for down converting the received signal using a local frequency corresponding to the mode and band to be received; a baseband processing module for controlling a receiver corresponding to the mode and band to be received among the receivers based on a predetermined control, baseband-processing the down converted reception signal, and outputting a baseband signal by classifying the baseband signal for each mode; and a modem module for outputting a control signal for receiving a signal of the mode and band to be received, controlling the local frequency to a local frequency corresponding to the mode and band to be received, and demodulating the baseband signal for each mode through a modem for each mode.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram illustrating a wireless communication system in which a multimode/multiband mobile station communicates with base stations operating based on various wireless interface standards;

FIG. 2 is a block diagram of a multimode/multiband mobile station according to a preferred first embodiment of the present invention;

FIG. 3 is a flowchart illustrating a search mode operation performed by the multimode/multiband mobile station according to the preferred first embodiment of the present invention;

FIG. 4 is a block diagram of a multimode/multiband mobile station according to a preferred second embodiment of the present invention;

FIG. 5 is a table illustrating frequency bands and services supported by the multimode/multiband mobile station according to the preferred second embodiment of the present invention;

FIG. 6 is a detailed circuit diagram of a world-oriented multimode/multiband mobile station according to the preferred second embodiment of the present invention;

FIG. 7 is a detailed circuit diagram of a Europe-oriented multimode/multiband mobile station according to the preferred second embodiment of the present invention;

FIG. 8 is a detailed circuit diagram of a United States-oriented multimode/multiband mobile station according to the preferred second embodiment of the present invention;

FIG. 9 is a block diagram illustrating a reception operation of the multimode/multiband mobile station according to the preferred second embodiment of the present invention;

FIG. 10 is a detailed circuit diagram of a baseband processing module and a modem module of the multimode/multiband mobile station according to the preferred second embodiment of the present invention;

FIGS. 11A and 11B are diagrams illustrating a method of controlling LNA gains of WCDMA/GSM receivers of the multimode/multiband mobile station according to the preferred second embodiment of the present invention; and

FIG. 12 is a block diagram illustrating a baseband signal processing operation of the multimode/multiband mobile station according to the preferred second embodiment of the present invention.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

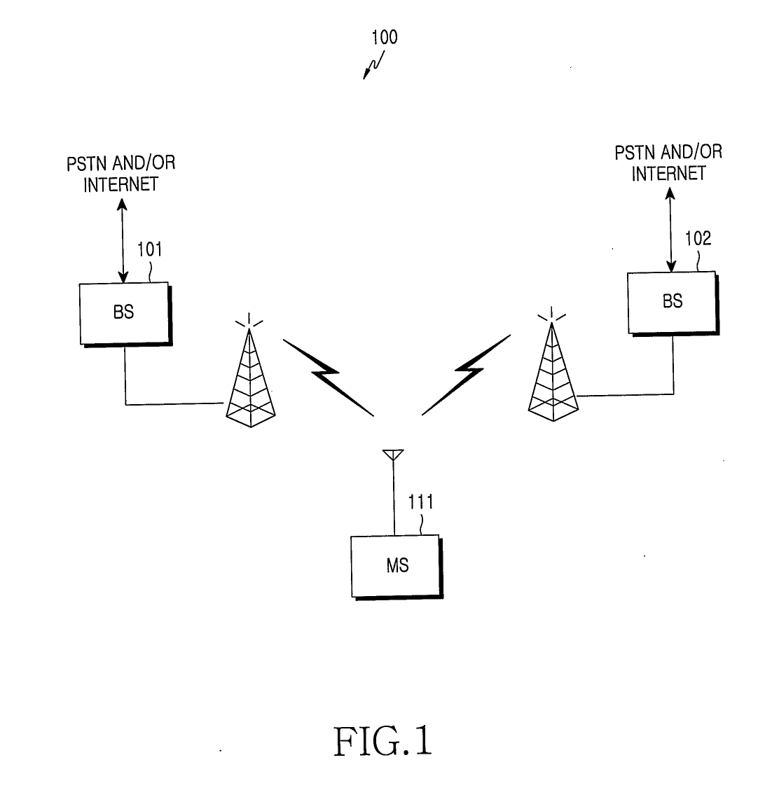

FIG. 1 is a schematic diagram illustrating a wireless communication system 100 in which a multimode/multiband mobile station (or wireless terminal) 111 communicates with base stations operating based on various wireless interface standards. In FIG. 1, it is assumed that a base station (BS) 101 is a portion of a first wireless network operating based on a first wireless interface standard (e.g., CDMA 2000). It is also assumed that a base station (BS) 102 is a portion of a second wireless network operating based on a second wireless interface standard (e.g., GSM). The mobile station (MS) 111 can communicate with the BS 101 by being configured through a first software load and communicate with the BS 102 by being reconfigured through a second software load. The software load can be manually selected by a user input or automatically selected by detecting a signal from the BS 101 or the BS 102.

The present invention is not limited to only actual mobile devices. In addition, the present invention is generally applied to other types of wireless terminals such as a fixed wireless terminal. However, description about only a mobile station will now be provided for simplicity and clearness. Though, the terminology “mobile station” used in claims and the description inclusively means an actual mobile device (e.g., wireless phone or wireless laptop) or a fixed wireless terminal (e.g., device monitor having wireless capability).

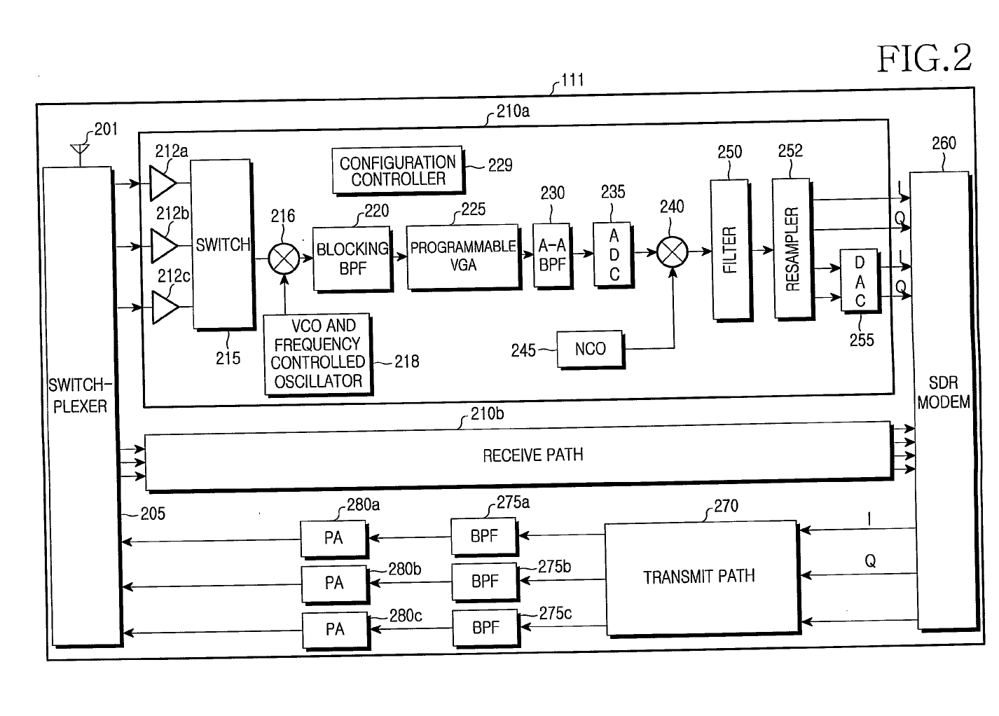

FIG. 2 is a block diagram of the multimode/multiband mobile station (MS) 111 according to a preferred first embodiment of the present invention. Referring to FIG. 2, the MS 111 includes an antenna array 201, a switchplexer 205, a reconfigurable receive path 210a, a reconfigurable receive path 210b and a reconfigurable software-defined radio (SDR) modem block 260. The SDR modem block 260 is typically a multi-purpose device or a semi-custom device, necessarily having characteristics changed by loading new software. The MS 111 also includes a transmit path 270 and a plurality of band pass filters (BPFs) 275, e.g., a BPF 275a, a BPF 275b and a BPF 275c. The MS 111 further includes a plurality of power amplifiers (PAs) 280, e.g., a PA 280a, a PA 280b and a PA 280 c.

The present embodiment implements a more efficient search algorithm using the same dual receive paths 210a and 210b, thereby more easily performing a roaming operation. Thus, even if a user moves to several areas in which different wireless standards are supported, the user can use the same mobile station. The dual path structure makes remote reconfiguration of an intermediate frequency (IF) filter and a digital IF possible. Since the reconfigurable receive paths 210a and 210b are actually the same, only the reconfigurable receive path 210a will now be described in detail. However, the description of the reconfigurable receive path 210a is applied to the reconfigurable receive path 210b with the same effect.

The reconfigurable receive path 210a includes an input end 212 comprised of selectable low noise amplifiers (LNAs), a switch 215, a broadband image rejection (IR) mixer 216, a voltage controlled oscillator (VCO) and frequency controlled oscillator block 218, configurable blocking BPF 220, a programmable variable gain amplifier (VGA) 225 and a configurable anti-alias BPF 230. The reconfigurable receive path 210a further includes a programmable analog/digital converter (ADC) 235, an IF mixer 240, a numerically-controlled oscillator (NCO) 245, a digital channel filter block 250, a re-sampler 252, a digital/analog converter (DAC) 255 and a configuration controller 229.

The configuration controller 229 controls configuration of the reconfigurable receive path 210a. According to a selected wireless interface, the configuration controller 229 performs reconfiguration of the reconfigurable blocks included in the reconfigurable receive path 210a by transmitting a command or configuration parameters to them. For simplicity, there are not shown connection lines between the configuration controller 229 and other components included in the reconfigurable receive path 210a.

The input end 212 comprised of selectable LNAs is, for example, comprised of an LNA 212a, an LNA 212b and an LNA 212c. The input end 212 comprised of selectable LNAs receives an incoming radio frequency (RF) signal from the switchplexer 205. Each of the LNA 212a, the LNA 212b and the LNA 212c is optimized to amplify the RF signal within a selected frequency range. For example, the selectable LNA 212a can amplify a signal within a range of 2.0 to 2.1 GHz with a minimum consumption power, another selectable LNA 212b can amplify a signal within a range of 1800 to 1900 MHz with a minimum consumption power, and the other selectable LNA 212c can amplify a signal within a range of 860 to 960 MHz with a minimum consumption power. By using LNAs, each optimized to a specific frequency band, the multimode/multiband capability of the MS 111 is intensified.

The switch 215 selects only one input signal among the selectable LNAs and provides the input signal to an input end of the broadband IR mixer 216. To reduce power consumption, LNAs not selected by the switch 215 may be turned off. The broadband IR mixer 216 receives a programmable reference signal from the VCO and frequency controlled oscillator block 218 and down converts the RF signal selected by the switch to an IF level, e.g., 10 MHz. The broadband IR mixer 216 performs near-zero intermediate frequency (NZIF) down conversion. It is preferable that the IR is performed by only the broadband IR mixer.

Interferers are removed by filtering an IF signal output from the broadband IR mixer 216 using the configurable blocking BPF 220. After filtering further proceeds using the configurable anti-alias BPF 230, the programmable VGA 225 adjusts the IF signal level to an optimized predetermined for ADC 235, after further filtering by configurable anti-alias bandpass filter (BPF) 230. In the present embodiment, the ADC 235 samples the IF signal at a rate of 40 Msps.

The digital IF sample generated by the ADC 235 is down-converted to a baseband by the IF mixer 240 and the NCO 245. Baseband In-phase I and Quadrature-phase Q signals output from the IF mixer 240 are filtered by the digital channel filter block 250. The filtered baseband I and Q signals are re-sampled by the re-sampler 252 and then matched to a rate of the SDR modem block 260. If the SDR modem block receives an analog input, the DAC 255 converts the digital I and Q signals to analog signals.

The NZIF down conversion allows a digital intermediate frequency (DIF) design of a low sampling rate for converting a current. The broadband IR mixer 216 is an advanced linear mixer, corresponding to an important block in an RF design. According to the new architecture, measurement using a received signal strength indicator (RSSI) measurement for a digital signal processing (DSP) function, i.e., a search function, through a receiver is possible, and current consumption can be optimized as well.

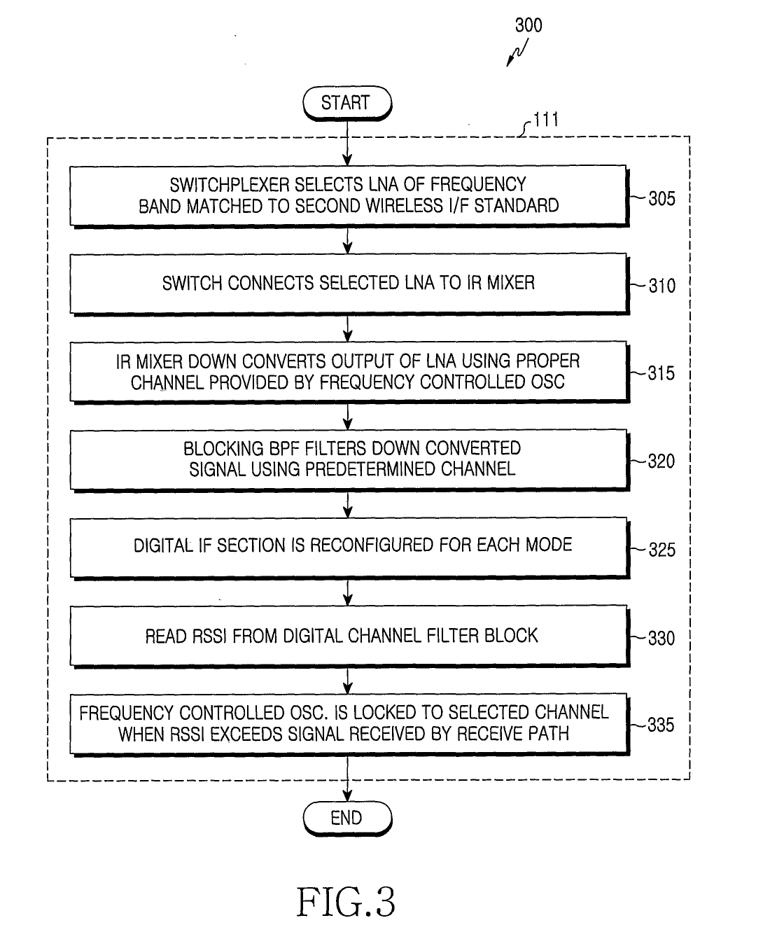

FIG. 3 is a flowchart 300 illustrating a search mode operation performed by the multimode/multiband mobile station 111 according to the preferred first embodiment of the present invention. It is assumed that the receive path 210b receives a signal based on a first wireless interface standard and the receive path 210a searches for a signal of a second wireless interface standard based on a set search algorithm. The switchplexer 205 selects one of input ends of the LNAs 212a to 212c, the input end belonging to a frequency band matched to the second wireless interface-standard, in step 305. The switch 215 connects an output of the selected LNA to an input of the broadband IR mixer 216 in step 310. The VCO and frequency controlled oscillator block 218 oscillates a frequency corresponding to a channel for a frequency band matched to the search algorithm, and the IR mixer 216 down converts the LNA output using the channel for the frequency band matched to the search algorithm in step 315. The blocking BPF 220 is also configured to filter the down-converted signal using a predetermined channel bandwidth in step 320.

The digital IF section (i.e., the IF mixer 240, the NCO 245, the filter block 250, the re-sampler 252 and the DAC 255) is reconfigured for each mode (e.g., GSM, general packet radio system (GPRS), Enhanced Data rate for GSM Evolution (EDGE)), CDMA, WCDMA or 802.11) in step 325. The received signal strength (RSS) can be measured by installing the received signal strength indicator (RSSI) in the output end of the digital channel filter block 250 in step 330. If the signal strength at the output end of the digital channel filter block 250 exceeds that of the signal received by the receive path 210b, the VCO and frequency controlled oscillator block 218 is locked to the selected channel in step 335. The modem 260 performs mode identification and reconfigures the anti-alias BPF 230.

In the multimode/multiband mobile station according to the preferred first embodiment of the present invention, LNAs for bands are included in each of the receive path 210b receiving a signal of the first wireless interface standard and the receive path 210a receiving a signal of the second wireless interface standard. The multimode/multiband mobile station performs communication by selecting one input of the LNAs for bands included in the dual receive paths.

Based on the configuration according to the preferred first embodiment of the present invention, the multimode/multiband mobile station (or terminal) for using in wireless networks operating under various wireless interface standards can be provided.

A multimode/multiband mobile station according to a preferred second embodiment of the present invention is configured to perform communication by selecting one input of LNAs for bands but using combined LNAs for frequency bands common to every wireless interface standard.

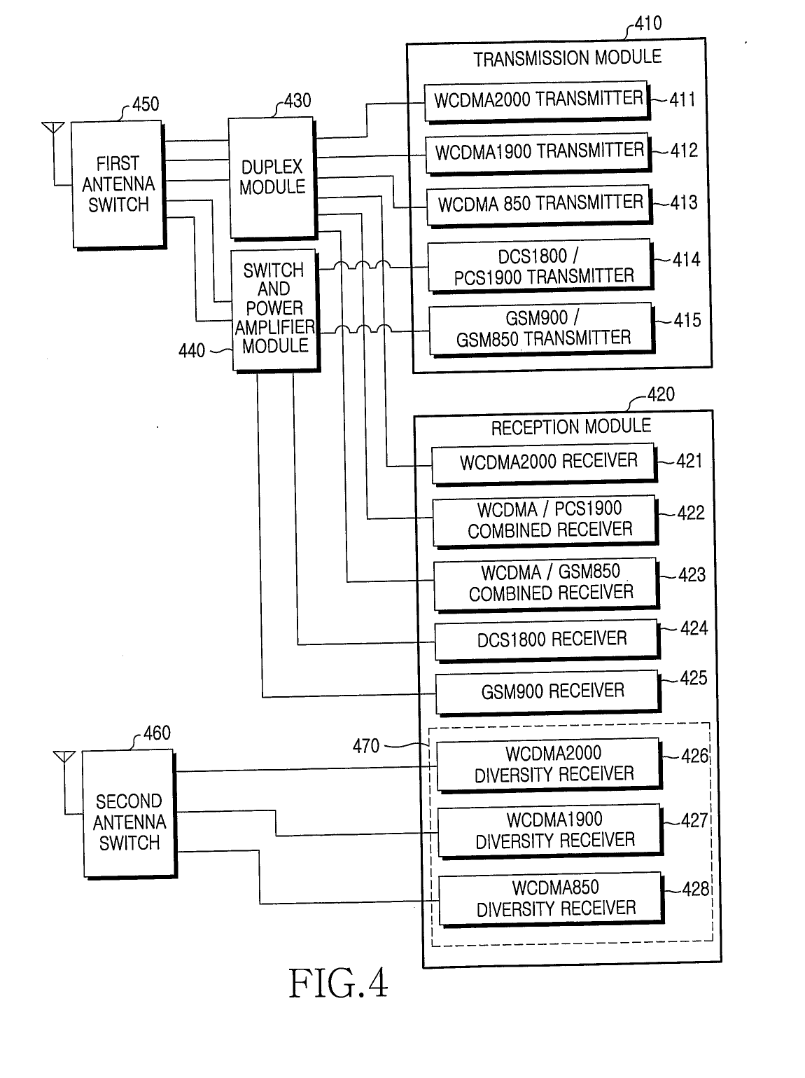

A multimode/multiband mobile station according to the preferred second embodiment of the present invention will now be described in detail. FIG. 4 is a block diagram of a multimode/multiband mobile station according to the preferred second embodiment of the present invention. FIG. 4 shows an example of a mobile station supporting WCDMA2000 MHz, WCDMA1900 MHz and WCDMA850 MHz bands corresponding to the first wireless interface standard, i.e., WCDMA services, and GSM850 MHz, GSM900 MHz, digital cellular system (DCS)1800 MHz and personal communication system (PCS)1900 MHz bands corresponding to the second wireless interface standard, i.e., GSM services.

Referring to FIG. 4, the multimode/multiband mobile station according to the preferred second embodiment of the present invention includes a transmission module 410, a reception module 420, a duplexer module 430, a switch and power amplifier module 440, a first antenna switch 450 and a second antenna switch 460.

The transmission module 410 includes transmitters for services and frequency bands and transmits a signal corresponding to a relevant communication service and frequency band through each transmitter. The transmission module 410, for example, can be configured by including a WCDMA2000 transmitter 411, a WCDMA1900 transmitter 412 and a WCDMA850 transmitter 413 for transmitting radio signals based on the first wireless interface standard of a frequency division duplex (FDD) technique and a DCS1800/PCS1900 transmitter 414 and a GSM850/GSM900 transmitter 415 for transmitting radio signals based on the second wireless interface standard of a time division duplex (TDD) technique. The transmission module 410 transmits a signal of a WCDMA2000 MHz band through the WCDMA2000 transmitter 411, a signal of a WCDMA1900 MHz band through the WCDMA1900 transmitter 412 and a signal of a WCDMA850 MHz band through the WCDMA850 transmitter 413. The transmission module 410 also transmits a signal of a DCS1800 MHz or PCS1900 MHz band through the DCS1800/PCS1900 transmitter 414 and a signal of a GSM850 MHz or GSM900 MHz band through the GSM850/GSM900 transmitter 415.

The reception module 420 includes receivers for services and frequency bands in order to support multi-modes and multi-bands, and more particularly, combined receivers, each including a combined LNA that can be used for different services of the same frequency band. In addition, the reception module 420 includes diversity receivers 470 for supporting WCDMA diversity.

The reception module 420, for example, includes a WCDMA2000 receiver 421, a WCDMA/PCS1900 combined receiver 422, a WCDMA/GSM850 combined receiver 423, a DCS1800 receiver 424, a GSM900 receiver 425, a WCDMA2000 diversity receiver 426, a WCDMA1900 diversity receiver 427 and a WCDMA850 diversity receiver 428.

The WCDMA/PCS1900 combined receiver 422 and the WCDMA/GSM850 combined receiver 423 are the combined receivers that can receive different service signals of the same frequency band. The WCDMA2000 diversity receiver 426, the WCDMA1900 diversity receiver 427 and the WCDMA850 diversity receiver 428 are the diversity receivers for supporting the WCDMA diversity.

The reception module 420 receives one service and frequency band, i.e., a signal of the WCDMA2000 MHz band, a signal of the DCS1800 MHz band or a signal of the GSM900 MHz band, through each of the WCDMA2000 receiver 421, the DCS1800 receiver 424 and the GSM900 receiver 425. The reception module 420 receives signals for different services of the same frequency band through the combined receivers such as the WCDMA/PCS1900 combined receiver 422 and the WCDMA/GSM850 combined receiver 423. That is, the reception module 420 receives a signal of the WCDMA1900 MHz band or a signal of the PCS1900 MHz band through the WCDMA/PCS1900 combined receiver 422 and receives a signal of the WCDMA850 MHz band or a signal of the GSM850 MHz band through the WCDMA/GSM850 combined receiver 423. The reception module 420 also receives a diversity signal of the WCDMA2000 MHz band through the WCDMA2000 diversity receiver 426, a diversity signal of the WCDMA1900 MHz band through the WCDMA1900 diversity receiver 427 and a diversity signal of the WCDMA850 MHz band through the WCDMA850 diversity receiver 428.

The duplexer module 430 is connected to the WCDMA2000 transmitter 411, the WCDMA1900 transmitter 412 and the WCDMA850 transmitter 413, which use the FDD technique, among the transmitters of the transmission module 410 and connected to the WCDMA2000 receiver 421 using the FDD technique and the WCDMA/PCS1900 combined receiver 422 and the WCDMA/GSM850 combined receiver 423, which use the FDD technique and the TDD technique together, among the receivers of the reception module 420. The duplexer module 430 divides a transmission signal output from each of the transmitters 411, 412 and 413 from a reception signal corresponding to the WCDMA2000 receiver 421, the WCDMA/PCS1900 combined receiver 422 or the WCDMA/GSM850 combined receiver 423. For the prior art, the duplexer module 430 is used to divide a transmission signal from a reception signal for only WCDMA signals based on the FDD technique, e.g., a technique of using different frequency bands for upstream and downstream. However, in the present embodiment, since a signal of the FDD technique (WCDMA signal) and a signal of the TDD technique (GSM850 or PCS1900 technique) are received by the combined receivers, the duplexer module 430 also plays a role of a reception module filter for the FDD technique and the TDD technique.

The switch and power amplifier module 440 is connected to the DCS1800/PCS1900 transmitter 414 and the GSM850/GSM900 transmitter 415 among the transmitters of the transmission module 410 and connected to the DCS1800 receiver 424 and the GSM900 receiver 425 among the receivers of the reception module 420. The switch and power amplifier module 440 divides a transmission signal output from the DCS1800/PCS1900 transmitter 414 or the GSM850/GSM900 transmitter 415 from a reception signal corresponding to the DCS1800 receiver 424 or the GSM900 receiver 425. The switch and power amplifier module 440 selects a frequency band to be transmitted from the DCS1800 MHz band and PCS1900 MHz band supported by the DCS1800/PCS1900 transmitter 414 and selects a frequency band to be transmitted from the GSM850 MHz band and GSM900 MHz band supported by the GSM850/GSM900 transmitter 415. The switch and power amplifier module 440 also amplifies power of a transmission signal of the DCS1800 MHz band or PCS1900 MHz band output from the DCS1800/PCS1900 transmitter 414 and amplifies power of a transmission signal of the GSM850 MHz band or GSM900 MHz band output from the GSM850/GSM900 transmitter 415.

The first antenna switch 450 is connected to the duplexer module 430 and the switch and power amplifier module 440, performs switching between an antenna and the duplexer module 430, and performs switching between the antenna and the switch and power amplifier module 440.

The second antenna switch 460 is connected to the diversity receivers 426, 427 and 428, and performs switching between an antenna and the diversity receivers 426, 427 and 428.

According to the preferred second embodiment of the present invention, the multimode/multiband mobile station configured as described above can reduce the number of receivers as compared with the conventional multimode/multiband mobile station by making use of one combined receiver for different services, i.e., modes, of the same frequency band and making use of a duplexer of the conventional FDD technique (e.g., WCDMA technique) in the TDD technique (e.g., GSM850 or PCS1900 technique).

The multimode/multiband mobile station according to the present embodiment can be configured to support all mobile communication services and frequency bands used over the world and configured to support mobile communication services and frequency bands used in a specific region (country).

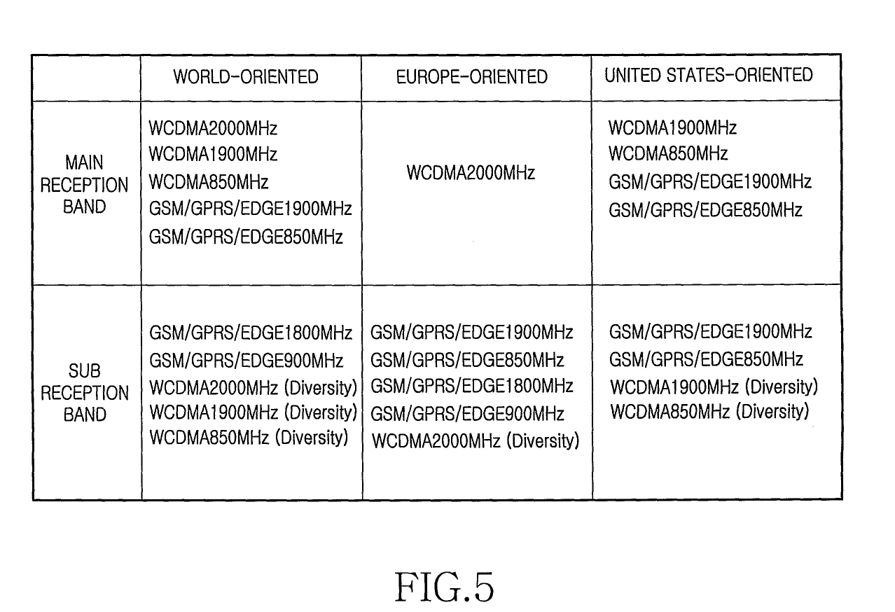

FIG. 5 is a table illustrating frequency bands and services supported by the multimode/multiband mobile station according to the present embodiment. Referring to FIG. 5, a world-oriented indicates a case where the multimode/multiband mobile station according to the present embodiment supports all mobile communication services and frequency bands used over the world. A Europe-oriented indicates a case where the multimode/multiband mobile station according to the present embodiment supports mobile communication services and frequency bands corresponding to the Europe region. A United States-oriented indicates a case where the multimode/multiband mobile station according to the present embodiment supports mobile communication services and frequency bands corresponding to the United States region.

The case where the multimode/multiband mobile station according to the preferred second embodiment of the present invention is implemented as the world-oriented will now be described. When the multimode/multiband mobile station is implemented as the world-oriented, the WCDMA2000 MHz, WCDMA1900 MHz, WCDMA850 MHz, GSM/GPRS/EDGE1900 MHz and GSM/GPRS/EDGE850 MHz bands most popularly used in the world use main receivers, and the GSM/GPRS/EDGE1800 MHz and GSM/GPRS/EDGE900 MHz bands and the diversity bands use sub-receivers.

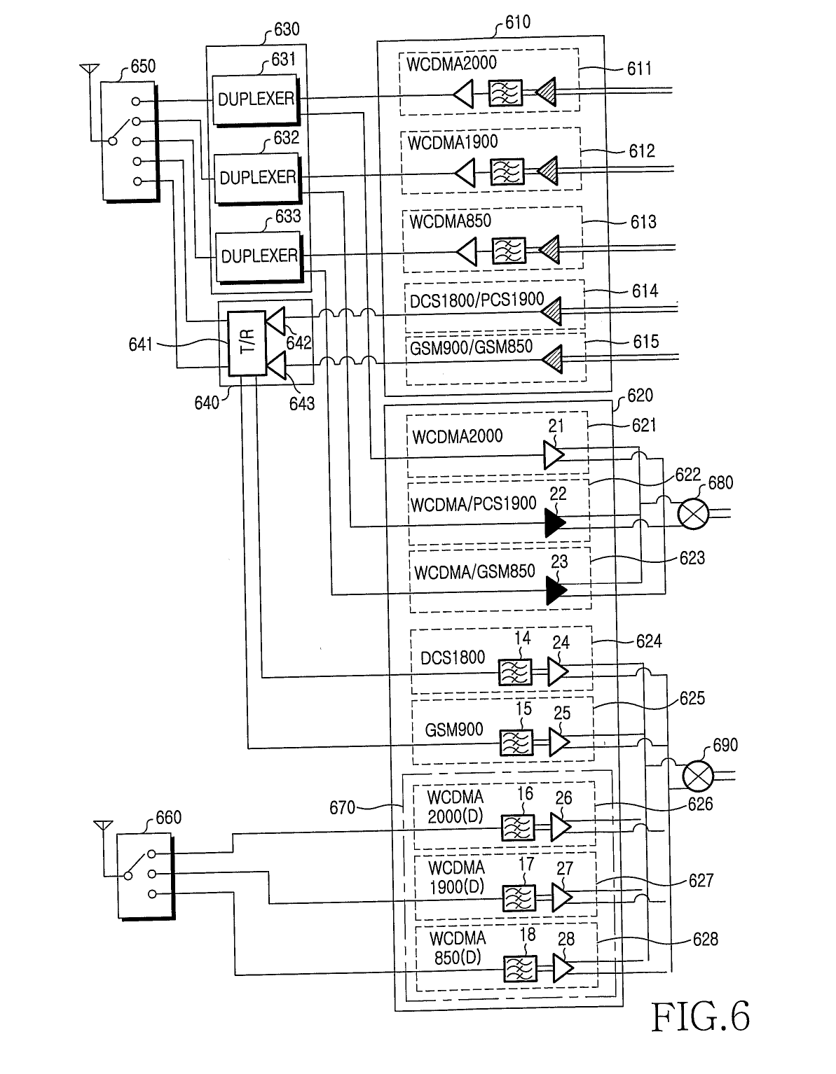

The case where the multimode/multiband mobile station according to the preferred second embodiment of the present invention is implemented as the world-oriented is shown in FIG. 6. FIG. 6 is a detailed circuit diagram of the world-oriented multimode/multiband mobile station according to the preferred second embodiment of the present invention.

Referring to FIG. 6, a transmission module 610 includes a WCDMA2000 transmitter 611, a WCDMA1900 transmitter 612 and a WCDMA850 transmitter 613 for transmitting radio signals based on the FDD technique and a DCS1800/PCS1900 transmitter 614 and a GSM900/GSM850 transmitter 615 for transmitting radio signals based on the TDD technique. The transmitters 611 to 615 include five pre-power amplifiers (PPAs) for amplifying power of a transmission signal, respectively.

A reception module 620 includes receivers for receiving the WCDMA2000 MHz, WCDMA1900 MHz, WCDMA850 MHz, GSM/GPRS/EDGE(PCS)1900 MHz, GSM/GPRS/EDGE(GSM)850 MHz, GSM/GPRS/EDGE1800 MHz and GSM/GPRS/EDGE900 MHz bands used all over the world. The reception module 620 includes individual receivers, each for receiving a signal for each mode and frequency band as described above, and combined receivers for the PCS1900 MHz band corresponding to the WCDMA1900 MHz band and the GSM/GPRS/EDGE1900 MHz band, which is the same frequency band for different services, and for the GSM850 MHz band corresponding to the WCDMA850 MHz band and the GSM/GPRS/EDGE850 MHz band, which is the same frequency band for different services. The reception module 620 also includes diversity receivers for supporting diversity of the WCDMA2000 MHz, WCDMA1900 MHz and WCDMA850 MHz bands.

Accordingly, the reception module 620 can be configured by including a WCDMA2000 receiver 621, a WCDMA/PCS1900 combined receiver 622, a WCDMA/GSM850 combined receiver 623, a DCS1800 receiver 624, a GSM900 receiver 625, a WCDMA2000 diversity receiver 626, a WCDMA1900 diversity receiver 627 and a WCDMA850 diversity receiver 628.

The WCDMA2000 receiver 621 includes a first LNA 21 amplifying a low signal received through an main antenna based on a WCDMA2000 service.

The WCDMA/PCS1900 combined receiver 622 includes a second LNA 22 amplifying a low signal received through the main antenna based on a WCDMA1900 service technique or a GSM/GPRS/EDGE1900 service technique, i.e., a PCS1900 service technique. The WCDMA/GSM850 combined receiver 623 includes a third LNA 23 amplifying a low signal received through the main antenna based on a WCDMA850 service technique or a GSM/GPRS/EDGE850 service technique, i.e., a GSM850 service technique. The DCS1800 receiver 624 includes a BPF 14, which passes a reception signal of the DCS1800 MHz band received through the main antenna and does not pass a leakage signal due to a transmission signal, and a fourth LNA 24 amplifying the received reception signal of the DCS1800 MHz band.

The GSM900 receiver 625 includes a BPF 15, which passes a reception signal of the GSM900 MHz band received through the main antenna and does not pass a leakage signal due to a transmission signal, and a fifth LNA 25 amplifying the received reception signal of the GSM900 MHz band.

The diversity receivers 670 include BPFs 16 to 18, which pass signals of diversity reception band received through a sub-antenna and do not pass leakage signals due to transmission signals, and LNAs 26 to 28 amplifying diversity signals, respectively.

A duplexer module 630 includes a first duplexer 631 connected to the WCDMA2000 transmitter 611 and the WCDMA2000 receiver 621, a second duplexer 632 connected to the WCDMA1900 transmitter 612 and the WCDMA/PCS1900 combined receiver 622, and a third duplexer 633 connected to the WCDMA850 transmitter 613 and the WCDMA/GSM850 combined receiver 623. The first duplexer 631 outputs a WCDMA2000 MHz transmission signal output from the WCDMA2000 transmitter 611 to the main antenna and outputs a WCDMA2000 MHz reception signal to the WCDMA2000 receiver 621. The second duplexer 632 outputs a WCDMA1900 MHz transmission signal output from the WCDMA1900 transmitter 612 to the main antenna and outputs a WCDMA/PCS1900 MHz reception signal to the WCDMA/PCS1900 combined receiver 622. The third duplexer 633 outputs a WCDMA850 MHz transmission signal output from the WCDMA850 transmitter 613 to the main antenna and outputs a WCDMA/GSM850 MHz reception signal to the WCDMA/GSM850 combined receiver 623.

A switch and power amplifier module 640 is connected to the DCS1800/PCS1900 transmitter 614 and the GSM850/GSM900 transmitter 615 among the transmitters of the transmission module 610 and connected to the DCS1800 receiver 624 and the GSM900 receiver 625 among the receivers of the reception module 620. The switch and power amplifier module 640 includes a transmission/reception and band selection switch 641, which selects a transmission/reception and band of each transmission/reception signal, and a first power amplifier 642 and second power amplifier 643 for amplifying power of each transmission signal.

The transmission/reception and band selection switch 641 performs switching for selectively outputting transmission signals of the DCS1800/PCS1900 MHz and GSM850/GSM900 MHz bands respectively output from the DCS1800/PCS1900 transmitter 614 and the GSM850/GSM900 transmitter 615 to the main antenna. The transmission/reception and band selection switch 641 also performs switching for outputting a reception signal of the DCS1800 MHz band and a reception signal of the GSM900 MHz band, which are received through the main antenna, to the corresponding DCS1800 receiver 624 and GSM900 receiver 625, respectively. The transmission/reception and band selection switch 641 also performs switching for selecting a frequency band to be transmitted among the DCS1800 MHz band and PCS1900 MHz band supported by the DCS1800 /PCS1900 transmitter 614 and for selecting a frequency band to be transmitted among the GSM850 MHz band and GSM900 MHz band supported by the GSM850/GSM900 transmitter 615. The first power amplifier 642 amplifies power of transmission signals of the DCS1800 MHz band and PCS1900 MHz band output from the DCS1800/PCS1900 transmitter 614. The second power amplifier 643 amplifies power of transmission signals of the GSM850 MHz band and GSM900 MHz band output from the GSM850/GSM900 transmitter 615.

A first antenna switch 650 is connected to the duplexer module 630 and the switch and power amplifier module 640, performs switching between the main antenna and the duplexer module 630, and performs switching between the main antenna and the switch and power amplifier module 640.

A second antenna switch 660 is connected to the diversity receivers 626 to 628 and performs switching between the sub-antenna and the diversity receivers 626 to 628.

A first mixer 680 is connected to each of the WCDMA2000 receiver 621, the WCDMA/PCS1900 combined receiver 622 and the WCDMA/GSM850 combined receiver 623 corresponding to a main reception band and converts a frequency of a high band received from each of the receivers 621 to 623 to a frequency of a low band.

A second mixer 690 is connected to each of the DCS1800 receiver 624, the GSM900 receiver 625 and the diversity receivers 626 to 628 corresponding to a sub reception band and converts a frequency of a high band received from each of the receivers 624 to 628 corresponding to the sub-band to a frequency of a low band.

As described above, the world-oriented multimode/multiband mobile station according to the preferred second embodiment of the present invention uses combined receivers receiving signals of the same frequency band (1900 MHz or 850 MHz) for different services (WCDMA/GSM/GPRS/EDGE) together. The WCDMA/PCS1900 combined receiver 622 and the WCDMA/GSM850 combined. receiver 623 among the receivers of the reception module 620 correspond to the combined receivers. The second LNA 22 of the WCDMA/PCS1900 combined receiver 622 amplifies a reception signal based on the WCDMA1900 service technique if a WCDMA1900 signal is received, and amplifies a reception signal based on the PCS1900 service technique if a PCS1900 signal is received. The third LNA 23 of the WCDMA/GSM850 combined receiver 623 amplifies a reception signal based on the WCDMA850 service technique if a WCDMA850 signal is received, and amplifies a reception signal based on the GSM850 service technique if a GSM850 signal is received.

In the preferred first embodiment of the present invention, since the LNAs amplifying only reception signals of single service techniques are used, the individual LNAs must be used for different services. However, in the preferred second embodiment of the present invention, as described above, by using the combined LNAs 22 and 23 that can amplify together reception signals of different service techniques (WCDMA signal or PCS signal, and WCDMA signal or GSM signal) if they are the same band, the number of LNAs can be reduced, and individual receivers for different services do not have to be prepared.

The multimode/multiband mobile station according to the preferred second embodiment of the present invention as described above needs less number of mixers by using the combined mixers 680 and 690, that for mixers necessary to the receivers 621 to 623 of the main reception band and this for the receivers 624 to 618 of the sub reception band.

In the above description, the multimode/multiband mobile station supporting frequency services and frequency bands used all over the world has been described as an example. However, in the Europe region, since communication services of the WCDMA1900 MHz band and WCDMA850 MHz band are not provided, transmitters/receivers of the WCDMA1900 MHz band and WCDMA850 MHz band are unnecessary.

Thus, a multimode/multiband mobile station supporting the WCDMA2000 MHz band, PCS1900 MHz band, DCS1800 MHz band, GSM900 MHz band and GSM850 MHz band used in the Europe region will now be described.

In particular, as shown in FIG. 5, in Europe, the WCDMA2000 MHz band is the main reception band, and the PCS1900 MHz band, DCS1800 MHz band, GSM900 MHz band and GSM850 MHz band are the sub reception band. Accordingly, a case where the Europe-oriented multimode/multiband mobile station according to the preferred second embodiment of the present invention uses a WCDMA2000 receiver as a main receiver and receives the PCS1900 MHz band, DCS1800 MHz band, GSM900 MHz band and GSM850 MHz band with sub-receivers will be described.

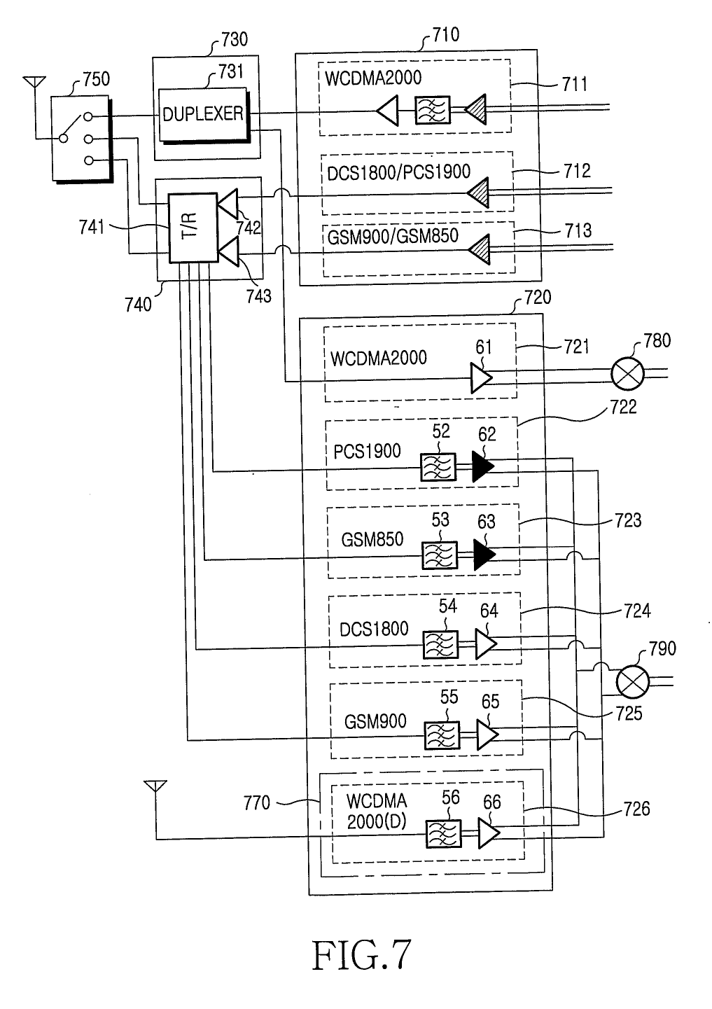

The Europe-oriented multimode/multiband mobile station according to the present embodiment is shown in FIG. 7. FIG. 7 is a detailed circuit diagram of the Europe-oriented multimode/multiband mobile station according to the present embodiment.

Referring to FIG. 7, a transmission module 710 of the Europe-oriented multimode/multiband mobile station according to the present embodiment includes a WCDMA2000 transmitter 711, a DCS1800/PCS1900 transmitter 712 and a GSM900/GSM850 transmitter 713. Each of the transmitters 711 to 713 outputs a transmission signal corresponding to its own service and frequency band.

A reception module 720 includes receivers for receiving the WCDMA2000 MHz, GSM/GPRS/EDGE(PCS)1900 MHz, GSM/GPRS/EDGE(GSM)850 MHz, GSM/GPRS/EDGE(DCS)1800 MHz and GSM/GPRS/EDGE(GSM)900 MHz bands.

That is, the reception module 720 can be configured by including a WCDMA2000 receiver 721, a PCS1900 receiver 722, a GSM850 receiver 723, a DCS1800 receiver 724, a GSM900 receiver 725 and a WCDMA2000(D) diversity receiver 726.

The WCDMA2000 receiver 721 includes an LNA 61 amplifying a low signal received through a main antenna based on a WCDMA2000 service.

The PCS1900 receiver 722 includes a BPF 52, which passes a reception signal of the PCS1900 MHz band received through the main antenna and does not pass a leakage signal due to a transmission signal, and an LNA 62 amplifying the received reception signal of the PCS1900 MHz band. Herein, though the LNA 62 is a combined LNA amplifying a WCDMA1900 MHz signal and a PCS1900 MHz signal together, in the Europe-oriented according to the present embodiment, the LNA 62 operates to amplify only the PCS1900 MHz signal since the WCDMA1900 MHz signal does not have to be received.

The GSM850 receiver 723 includes a BPF 53, which passes a reception signal of the GSM850 MHz band received through the main antenna and does not pass a leakage signal due to a transmission signal, and an LNA 63 amplifying the received reception signal of the GSM850 MHz band. Herein, though the LNA 63 is a combined LNA amplifying a WCDMA850 MHz signal and a GSM850 MHz signal together, in the Europe-oriented according to the present embodiment, the LNA 63 operates to amplify only the GSM850 MHz signal since the WCDMA850 MHz signal does not have to be received.

The DCS1800 receiver 724 includes a BPF 54, which passes a reception signal of the DCS1800 MHz band received through the main antenna and does not pass a leakage signal due to a transmission signal, and an LNA 64 amplifying the received reception signal of the DCS1800 MHz band.

The GSM900 receiver 725 includes a BPF 55, which passes a reception signal of the GSM900 MHz band received through the main antenna and does not pass a leakage signal due to a transmission signal, and an LNA 65 amplifying the received reception signal of the GSM900 MHz band.

The WCDMA2000 diversity receiver 726 includes a BPF 56, which passes a diversity signal of the WCDMA2000 MHz band received through a sub-antenna and does not pass a leakage signal due to a transmission signal, and an LNA 66 amplifying the diversity signal.

A duplexer module 730 includes a duplexer 731 connected to the WCDMA2000 transmitter 711 and the WCDMA2000 receiver 721. The duplexer 731 outputs a WCDMA2000 MHz transmission signal output from the WCDMA2000 transmitter 711 to the main antenna and outputs a WCDMA2000 MHz reception signal to the WCDMA2000 receiver 721.

A switch and power amplifier module 740 is connected to the DCS1800/PCS1900 transmitter 712 and GSM850/GSM900 transmitter 713 of the transmission module 710 and connected to the PCS1900 receiver 722, GSM900 receiver 723, DCS1800 receiver 724 and GSM900 receiver 725 of the reception module 720. The switch and power amplifier module 740 includes a transmission/reception and band selection switch 741, which selects a transmission/reception and band of each transmission/reception signal, and a first power amplifier 642 and second power amplifier 643 for amplifying power of each transmission signal.

The transmission/reception and band selection switch 741 divides transmission signals output from the DCS1800/PCS1900 transmitter 712 and the GSM900/GPRS900 transmitter 713 from reception signals corresponding to the PCS1900 receiver 722, GSM900 receiver 723, DCS1800 receiver 724 and GSM900 receiver 725. The transmission/reception and band selection switch 741 also selects a frequency band to be transmitted among the DCS1800 MHz band and PCS1900 MHz band supported by the DCS1800/PCS1900 transmitter 712 and selects a frequency band to be transmitted among the GSM850 MHz band and GSM900 MHz band supported by the GSM850/GSM900 transmitter 713. The first power amplifier 742 amplifies power of transmission signals of the DCS1800 MHz band and PCS1900 MHz band output from the DCS1800/PCS1900 transmitter 712. The second power amplifier 743 amplifies power of transmission signals of the GSM850 MHz band and GSM900 MHz band output from the GSM850/GSM900 transmitter 713.

A first antenna switch 750 is connected to the duplexer module 730 and the switch and power amplifier module 740, performs switching between the main antenna and the duplexer module 730, and performs switching between the main antenna and the switch and power amplifier module 740.

A first mixer 780 is connected to the WCDMA2000 receiver 721 for receiving a signal of a main reception band and converts a frequency of a high band received from WCDMA2000 receiver 721 to a frequency of a low band.

A second mixer 790 is connected to the PCS1900 receiver 722, GSM900 receiver 723, DCS1800 receiver 724, GSM900 receiver 725 and WCDMA2000 diversity receiver 726 for receiving signals of a sub reception band and converts a frequency of a high band received from each of the receivers 722 to 726 to a frequency of a low band.

As described above, in the Europe-oriented multimode/multiband mobile station according to the present embodiment, though the LNA 62 is a combined LNA amplifying a WCDMA1900 MHz signal and a PCS1900 MHz signal together, the LNA 62 is used to amplify only the PCS1900 MHz signal since the WCDMA1900 MHz signal is not used. In addition, though the LNA 63 is a combined LNA amplifying a WCDMA850 MHz signal and a GSM850 MHz signal together, the LNA 63 is used to amplify only the GSM850 MHz signal since the WCDMA850 MHz signal is not used.

The Europe-oriented multimode/multiband mobile station according to the present embodiment needs less number of mixers by using the combined mixers 780 and 790, that for mixers necessary to the receiver 721 of the main reception band and this for the receivers 722 to 726 of the sub reception band.

As shown in FIG. 5, in the United States, the WCDMA1900 MHz band, the WCDMA850 MHz band, the GSM/GPRS/EDGE(PCS)1900 MHz band and the GSM/GPRS/EDGE(GSM)850 MHz band are the main reception band, and the GSM/GPRS/EDGE(DCS)1800 MHz band and the GSM/GPRS/EDGE(GSM)900 MHz band are the sub reception band. Accordingly, a case where the United States-oriented multimode/multiband mobile station according to the present embodiment uses WCDMA1900, WCDMA850, PCS1900 and GSM850 receivers as main receivers and uses DCS1800 and GSM900 receivers and diversity receivers as sub receivers will be described.

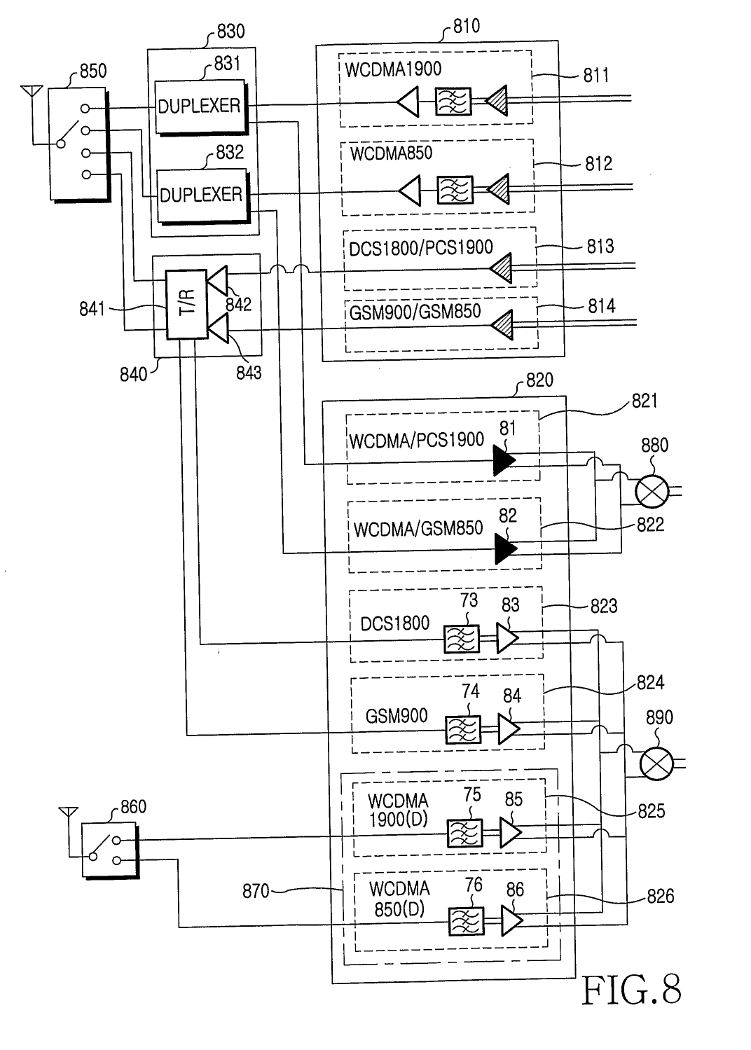

The United States-oriented multimode/multiband mobile station according to the present embodiment is shown in FIG. 8. FIG. 8 is a detailed circuit diagram of the United States-oriented multimode/multiband mobile station according to the present embodiment.

Referring to FIG. 8, a transmission module 810 of the United States-oriented multimode/multiband mobile station according to the present embodiment includes a WCDMA1900 transmitter 811, a WCDMA850 transmitter 812, a DCS1800/PCS1900 transmitter 813 and a GSM900/GSM850 transmitter 814. Each of the transmitters 811 to 814 outputs a transmission signal corresponding to its own service and frequency band.

A reception module 820 includes receivers for receiving signals of the WCDMA1900 MHz, WCDMA850 MHz, GSM/GPRS/EDGE(PCS)1900 MHz, GSM/GPRS/EDGE(GSM)850 MHz, GSM/GPRS/EDGE(DCS)1800 MHz and GSM/GPRS/EDGE900 MHz bands and signals of the WCDMA1900 MHz band and WCDMA850 MHz band.

The reception module 820 can be configured by including a WCDMA/PCS1900 combined receiver 821, a WCDMA/GSM850 combined receiver 822, a DCS1800 receiver 823, a GSM900 receiver 824, a WCDMA1900(D) diversity receiver 825 and a WCDMA850(D) diversity receiver 826.

The WCDMA/PCS1900 combined receiver 821 includes an LNA 81 amplifying a low signal received through a main antenna based on the WCDMA1900 service technique or the GSM/GPRS/EDGE(PCS)1900 service technique. The WCDMA/GSM850 combined receiver 822 includes an LNA 82 amplifying a low signal received through the main antenna based on the WCDMA850 service technique or the GSM/GPRS/EDGE(GSM)850 service technique.

The DCS1800 receiver 823 includes a BPF 73, which passes a reception signal of the DCS1800 MHz band received through the main antenna and does not pass a leakage signal due to a transmission signal, and an LNA 83 amplifying the received reception signal of the DCS1800 MHz band.

The GSM900 receiver 824 includes a BPF 74, which passes a reception signal of the GSM900 MHz band received through the main antenna and does not pass a leakage signal due to a transmission signal, and an LNA 84 amplifying the received reception signal of the GSM900 MHz band.

The WCDMA1900(D) diversity receiver 825 include a BPF 75, which passes a WCDMA1900 MHz diversity signal received through a sub-antenna and does not pass a leakage signal due to a transmission signal, and an LNA 85 amplifying the received WCDMA1900 MHz diversity signal.

The WCDMA850(D) diversity receiver 826 include a BPF 76, which passes a WCDMA850 MHz diversity signal received through the sub-antenna and does not pass a leakage signal due to a transmission signal, and an LNA 86 amplifying the received WCDMA850 MHz diversity signal.

A duplexer module 830 includes a first duplexer 831 connected to the WCDMA1900 transmitter 811 and the WCDMA/PCS1900 combined receiver 821 and a second duplexer 832 connected to the WCDMA850 transmitter 812 and the WCDMA/GSM850 combined receiver 822.

The first duplexer 831 outputs a WCDMA1900 MHz transmission signal output from the WCDMA1900 transmitter 811 to the main antenna and outputs a WCDMA1900 MHz reception signal or a PCS1900 MHz signal received through the main antenna to the WCDMA/PCS1900 combined receiver 821.

The second duplexer 832 outputs a WCDMA850 MHz transmission signal output from the WCDMA850 transmitter 812 to the main antenna and outputs a WCDMA850 MHz reception signal or a GSM850 MHz signal received through the main antenna to the WCDMA/GSM850 combined receiver 822.

A switch and power amplifier module 840 is connected to each of the DCS1800/PCS1900 transmitter 813 and GSM850/GSM900 transmitter 814 of the transmission module 810 and connected to each of the DCS1800 receiver 823 and GSM900 receiver 824 of the reception module 820. The switch and power amplifier module 840 includes a transmission/reception and band selection switch 841, which selects a transmission/reception and band of each transmission/reception signal, and a first power amplifier 842 and second power amplifier 843 for amplifying power of each transmission signal.

The transmission/reception and band selection switch 841 performs switching for selectively outputting a transmission signal of the DCS1800/PCS1900 MHz band and a transmission signal of the GSM850/GSM900 MHz band respectively output from the DCS1800/PCS1900 transmitter 813 and the GSM850/GSM900 transmitter 814 to the main antenna. The transmission/reception and band selection switch 841 also performs switching for outputting a reception signal of the DCS1800 MHz band and a reception signal of the GSM900 MHz band, which are received through the main antenna, to the corresponding DCS1800 receiver 823 and GSM900 receiver 824, respectively. The transmission/reception and band selection switch 841 also performs switching for selecting a frequency band to be transmitted among the DCS1800 MHz band and PCS1900 MHz band supported by the DCS1800/PCS1900 transmitter 813 and for selecting a frequency band to be transmitted among the GSM850 MHz band and GSM900 MHz band supported by the GSM850/GSM900 transmitter 814. The first power amplifier 842 amplifies power of transmission signals of the DCS1800 MHz band and PCS1900 MHz band output from the DCS1800/PCS1900 transmitter 813. The second power amplifier 843 amplifies power of transmission signals of the GSM850 MHz band and GSM900 MHz band output from the GSM850/GSM900 transmitter 814.

A first antenna switch 850 is connected to the duplexer module 830 and the switch and power amplifier module 840, performs switching between the main antenna and the duplexer module 830, and performs switching between the main antenna and the switch and power amplifier module 840.

A second antenna switch 860 is connected to the diversity receivers 825 and 826 and performs switching between the sub-antenna and the diversity receivers 825 and 826.

A first mixer 880 is connected to the receivers 821 and 822 receiving the WCDMA1900 MHz, WCDMA850 MHz, PCS1900 MHz and GSM850 MHz bands, i.e., a main reception band, and converts a frequency of a high band of each of the main reception band signals to a frequency of a low band.

A second mixer 890 is connected to each of the receivers 823 to 826 receiving signals of the PCS1900 MHz and GSM850 MHz bands and receiving a sub reception band corresponding to diversity bands of the WCDMA1900 MHz and WCDMA850 MHz bands and converts a frequency of a high band of each of the sub reception band signals to a frequency of a low band.

As described above, the United States-oriented multimode/multiband mobile station according to the present embodiment uses the WCDMA/PCS1900 combined receiver 821 and WCDMA/GSM850 combined receiver 822 receiving signals of the same frequency band (1900 MHz or 850 MHz) for different wireless interface standards (WCDMA/DCS or GSM) together. The LNA 81 of the WCDMA/PCS1900 combined receiver 821 amplifies a reception signal based on the WCDMA1900 service technique if a WCDMA1900 signal is received, and amplifies a reception signal based on the PCS1900 service technique if a PCS1900 signal is received. The LNA 82 of the WCDMA/GSM850 combined receiver 822 amplifies a reception signal based on the WCDMA850 service technique if a WCDMA850 signal is received, and amplifies a reception signal based on the GSM850 service technique if a GSM850 signal is received. In the present embodiment, as described above, by using the combined LNAs 81 and 82 that can amplify together reception signals of different wireless interface standards (WCDMA signal or PCS signal, and WCDMA signal or GSM signal) if they are the same band, the number of LNAs can be reduced, and individual receivers for different services do not have to be prepared.

The United States-oriented multimode/multiband mobile station according to the present embodiment needs less number of mixers by using the combined mixers 880 and 890, that for mixers necessary to the receivers 821 and 822 of the main reception band and this for mixers necessary to the receivers 823 to 826 of the sub reception band.

A signal reception operation of the multimode/multiband mobile station according to the preferred second embodiment of the present invention as described above will now be described in detail.

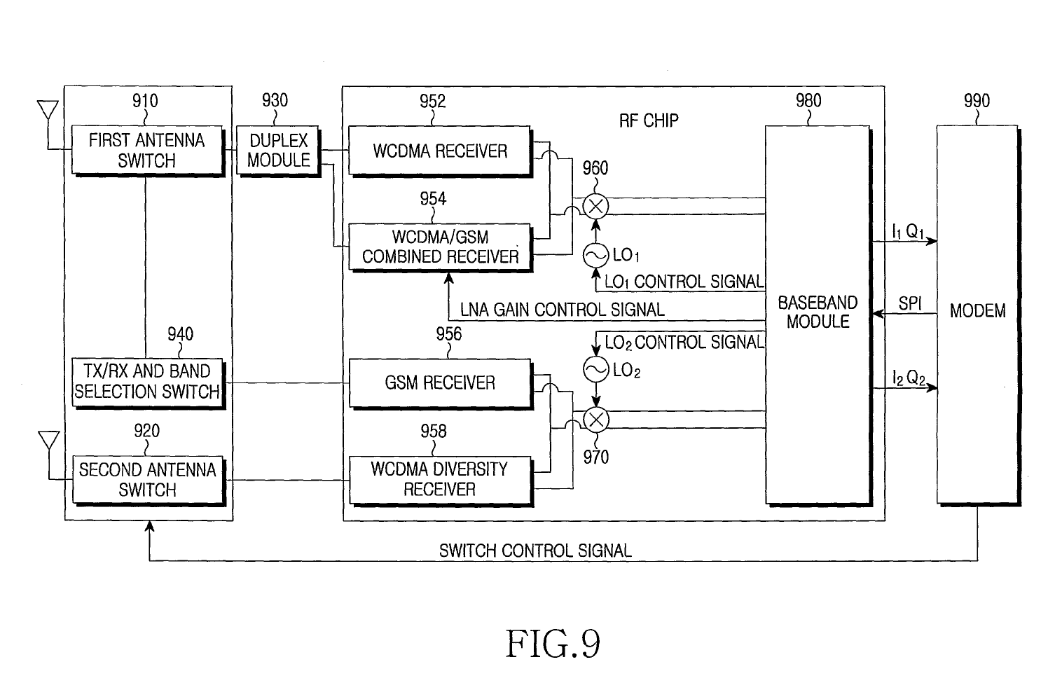

FIG. 9 is a block diagram illustrating the reception operation of the multimode/multiband mobile station according to the preferred second embodiment of the present invention. FIG. 9 shows components for the reception operation, a baseband processing module and a modem module among components of the multimode/multiband mobile station according to the preferred second embodiment of the present invention.

Referring to FIG. 9, the modem module 990 outputs a switch control signal and an SPI signal for receiving a desired band signal of a desired mode among multimode/multiband signals.

The switch control signal includes a first switch control signal for controlling a first antenna switch 910, a third switch control signal for controlling a second antenna switch 920, and a second switch control signal for controlling a transmission/reception and band selection switch 940.

The first switch control signal is a control signal for selecting a reception mode (WCDMA or GSM) and a reception frequency band of a main reception signal among the multimode/multiband signals and is provided to the first antenna switch 910. The second switch control signal is a signal for selecting a frequency band of a GSM mode in a state where the reception mode has been selected as the GSM mode by the first switch control signal and is provided to the transmission/reception and band selection switch 940. The third switch control signal is a signal for selecting whether WCDMA diversity reception is performed and is provided to the second antenna switch 920.

The first antenna switch 910 connects a first antenna to a duplexer of a selected mode and band among duplexers of a duplexer module 930 or connects the first antenna to the transmission/reception and band selection switch 940 by performing a switching operation in response to the first switch control signal. The duplexer module 930 includes duplexers for receiving bands of the WCDMA mode and duplexers for receiving bands of a WCDMA/GSM combined mode. When the duplexers for receiving bands of the WCDMA mode are connected to the first antenna, they transmit a signal received through the first antenna to a WCDMA receiver 952. When the duplexers for receiving bands of the WCDMA/GSM combined mode are connected to the first antenna, they transmit a signal of a combined band of the WCDMA or GSM mode received through the first antenna to a WCDMA/GSM combined receiver 954.

The transmission/reception and band selection switch 940 transfers a signal through the first antenna to a GSM receiver 956 of a selected band through the first antenna switch 910 by connecting the first antenna switch 910 to the GSM receiver 956 of the selected band in response to the second switch control signal.

The second antenna switch 920 selects whether to receive a WCDMA diversity signal in response to the third switch control signal. If the second antenna switch 920 is selected to receive a WCDMA diversity signal, the second antenna switch 920 transfers a WCDMA diversity signal received through a second antenna to a WCDMA diversity reception module 958 by connecting the second antenna to a selected band receiver of the WCDMA diversity reception module 958.

Each of the WCDMA receiver 952, WCDMA/GSM combined receiver 954, GSM receiver 956 and WCDMA diversity reception module 958 receives a signal of a corresponding mode and band and low-noise-amplifies the received signal in a method suitable for the corresponding mode and band.

The baseband processing module 980 controls to operate only one receiver corresponding to a mode and band to be received among the WCDMA receiver 952, WCDMA/GSM combined receiver 954, GSM receiver 956 and WCDMA diversity reception module 958 in response to the SPI signal.

When a signal of the mode and band to be received is received through the WCDMA/GSM combined receiver 954, the baseband processing module 980 controls an LNA gain of the WCDMA/GSM combined receiver 954 based on whether the received signal is a WCDMA signal or a GSM signal. For example, if the signal received through the WCDMA/GSM combined receiver 954 is the WCDMA signal, the baseband processing module 980 outputs an LNA control signal to control the LNA gain of the WCDMA/GSM combined receiver 954 to a gain corresponding to the WCDMA mode. If the received signal is the GSM signal, the baseband processing module 980 outputs an LNA control signal to control the LNA gain of the WCDMA/GSM combined receiver 954 to a gain corresponding to the GSM mode.

In addition, the baseband processing module 980 controls a first local frequency L01 provided to a first mixer 960 and a second local frequency L02 provided to a second mixer 970 in response to the SPI signal. For example, if the signal of the mode and band to be received is a WCDMA/GSM combined mode band signal received through the WCDMA/GSM combined receiver 954, the baseband processing module 980 controls the first local frequency L01 to a corresponding WCDMA channel frequency or GSM channel frequency in response to the SPI signal. If the signal of the mode and band to be received is a GSM mode band signal received through the GSM receiver 956, the baseband processing module 980 controls the second local frequency L02 to a corresponding GSM channel frequency in response to the SPI signal.

The first mixer 960 down converts a signal low-noise-amplified by the WCDMA receiver 952 and WCDMA/GSM combined receiver 954, i.e., main band receivers, using the first local frequency controlled for modes and bands. The second mixer 970 down converts a signal low-noise-amplified by the GSM receiver 956 and WCDMA diversity reception module 958, i.e., sub-band receivers, using the second local frequency controlled for modes and bands.

The baseband processing module 980 converts signals down converted by the first mixer 960 and second mixer 970 to first and second baseband signals, respectively, and classifies the converted first and second baseband signals into a WCDMA baseband signal and a GSM baseband signal.

The modem module 990 demodulates each of the WCDMA baseband signal and GSM baseband signal output from the baseband processing module 980 using its corresponding modem.

In other words, by the signal reception operation of the multimode/multiband mobile station according to the preferred second embodiment of the present invention, the modem module 990 outputs the switch control signal and the SPI signal for receiving a desired band signal of a desired mode among multimode/multiband signals.

The first antenna switch 910, transmission/reception and band selection switch 940 and second antenna switch 920 perform switching for selecting a reception mode (WCDMA or GSM) and reception frequency band, a frequency band when the reception mode is the GSM mode, and whether the WCDMA diversity reception is performed.

The baseband processing module 980 controls to operate only one receiver corresponding to a mode and band to be received among the receivers for modes and bands in response to the SPI signal received from the modem module 990. The baseband processing module 980 converts the received signal to a baseband signal and classifies whether the baseband signal is a WCDMA baseband signal or a GSM baseband signal.

The modem module 990 demodulates each of the WCDMA baseband signal and GSM baseband signal output from the baseband processing module 980 using its corresponding modem.

The signal reception operation of the multimode/multiband mobile station according to the preferred second embodiment of the present invention as described above will now be described in more detail.

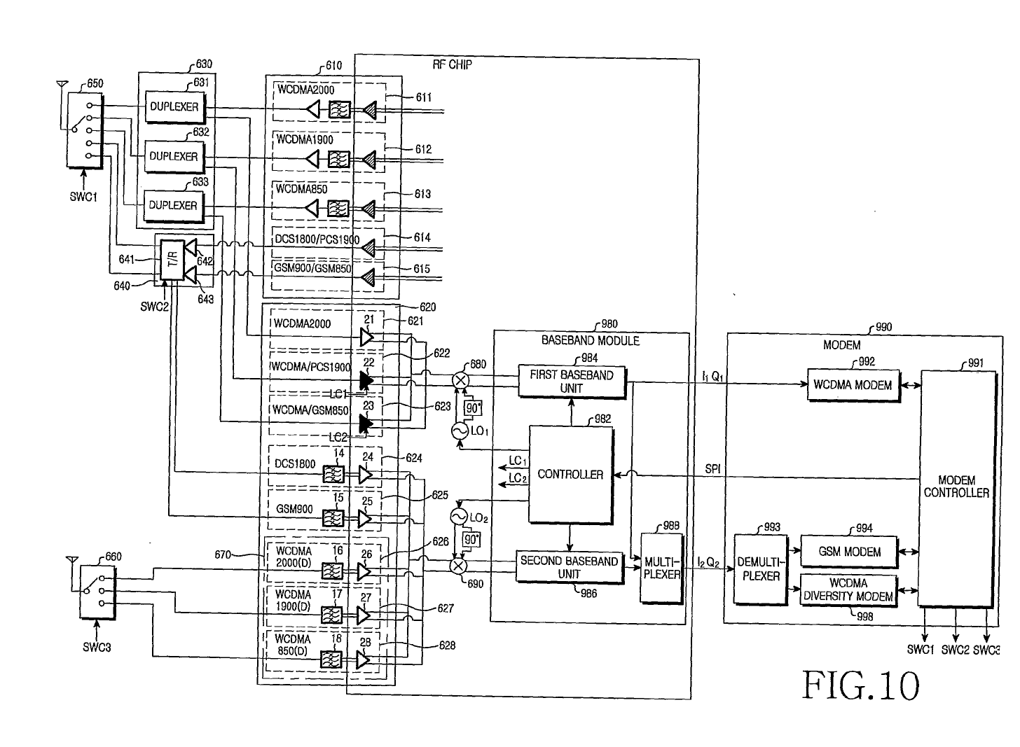

FIG. 10 is a detailed circuit diagram of the baseband processing module 980 and modem module 990 for performing the signal reception operation of the multimode/multiband mobile station according to the preferred second embodiment of the present invention.

FIG. 10 shows an example of the multimode/multiband mobile station according to the preferred second embodiment of the present invention, which supports WCDMA2000, WCDMA1900, WCDMA850, DCS1800, PCS1900, GSM900 and GSM850 signals.

Referring to FIG. 10, the transmission module 610, reception module 620, duplexer module 630, switch and power, amplifier module 640, first antenna switch 650, second antenna switch 660, first mixer 680 and second mixer 690 are similar to those described in FIG. 6. Accordingly, for the transmission module 610, reception module 620, duplexer module 630, switch and power amplifier module 640, first antenna switch 650, second antenna switch 660, first mixer 680 and second mixer 690, the description of FIG. 6 is referred to, and a detailed description of them is omitted. Here, configurations and operations of the baseband processing module 980 and modem module 990 will be mainly described.

A modem controller 991 of the modem module 990 outputs first to third switch control signals SWC1, SWC2 and SWC3 for receiving a desired mode and band signal among WCDMA2000, WCDMA1900, WCDMA850, DCS1800, PCS1900, GSM900 and GSM850 signals.

The first switch control signal SWC1 is a control signal for selecting a desired reception mode (WCDMA or GSM) and reception frequency band among the WCDMA2000, WCDMA1900, WCDMA850, DCS1800, PCS1900, GSM900 and GSM850 signals.

The first antenna switch 650 makes a receiver corresponding to the desired reception mode and band selected by connecting the first antenna to a duplexer of a corresponding mode and band among the first to third duplexers 631 to 633 of the duplexer module 630 or connecting the first antenna to the switch and power amplifier module 640.

For example, when the first switch control signal for receiving a signal of the GSM850 band is received, the first antenna switch 650 makes a GSM850 signal received through the first antenna transferred to the WCDMA/GSM850 combined receiver 623 by connecting the first antenna to the third duplexer 633. When the first switch control signal for receiving a signal of the DCS1800 band, the first antenna switch 650 also makes a signal received through the first antenna transferred to the DCS1800 receiver 624 through the transmission/reception and band selection switch 641 by connecting the first antenna to the transmission/reception and band selection switch 641.

The transmission/reception and band selection switch 641 makes a desired GSM receiver selected by connecting the first antenna switch 650 to a GSM receiver of a corresponding band in response to the second switch control signal SWC2. For example, when the second switch control signal for receiving a signal of the GSM900 band among GSM reception signals is received, the transmission/reception and band selection switch 641 makes a signal received through the first antenna switch 650 transferred to the GSM900 receiver 625 by connecting the first antenna switch 650 to the GSM900 receiver 625.

The second antenna switch 660 makes whether to receive a WCDMA diversity signal selected by performing a switching operation for connecting or releasing the second antenna to or from a corresponding band receiver of the WCDMA diversity reception module 670 in response to the third switch control signal SWC3.

The modem controller 991 of the modem module 990 outputs the first to third switch control signals SWC1, SWC2 and SWC3 for receiving a desired mode and band signal as described above and simultaneously outputs an SPI signal for processing the received signal to the baseband processing module 980.

The baseband processing module 980 includes a controller 982, a first baseband processing unit 984, a second baseband processing unit 986 and a multiplexer 988.

The controller 982 controls to operate only receivers corresponding to a mode and band to be received among the receivers 621 to 628 for modes and bands in response to the SPI signal received from the modem controller 991. For example, if a signal to be received is the WCDMA2000 band, the controller 982 controls to operate only the WCDMA2000 receiver 621 and WCDMA2000(D) receiver 626 in response to the SPI signal received from the modem controller 991. If the signal to be received is the GSM850 band, the controller 982 controls to operate only the WCDMA/GSM850 combined receiver 623 in response to the SPI signal received from the modem controller 991.

If the signal to be received is the WCDMA/GSM combined band, the controller 982 outputs a control signal to control an LNA gain of a WCDMA/GSM combined receiver to a WCDMA or GSM gain. For example, if the signal to be received is one of WCDMA/PCS1900 bands, the controller 982 outputs a signal LC1 to control a gain of the LNA 22 of the WCDMA/PCS1900 combined receiver 622 to a gain corresponding to one of the WCDMA1900 and PCS1900 bands. If the signal to be received is one of WCDMA/GSM850 bands, the controller 982 outputs a signal LC2 to control a gain of the LNA 23 of the WCDMA/GSM850 combined receiver 623 to a gain corresponding to one of the WCDMA850 and GSM850 bands.

Each of the receivers 621 to 628 for modes and bands low-noise-amplifies a signal corresponding to its own band in response to a control of the controller 982. In particular, the WCDMA/PCS1900 combined receiver 622 and the WCDMA/GSM850 combined receiver 623 control the LNA gain to the gain corresponding to the WCDMA and the gain corresponding to the GSM in response to the signals LC1 and LC2 received from the controller 982 and simultaneously low-noise-amplify a WCDMA signal and a GSM signal, respectively.

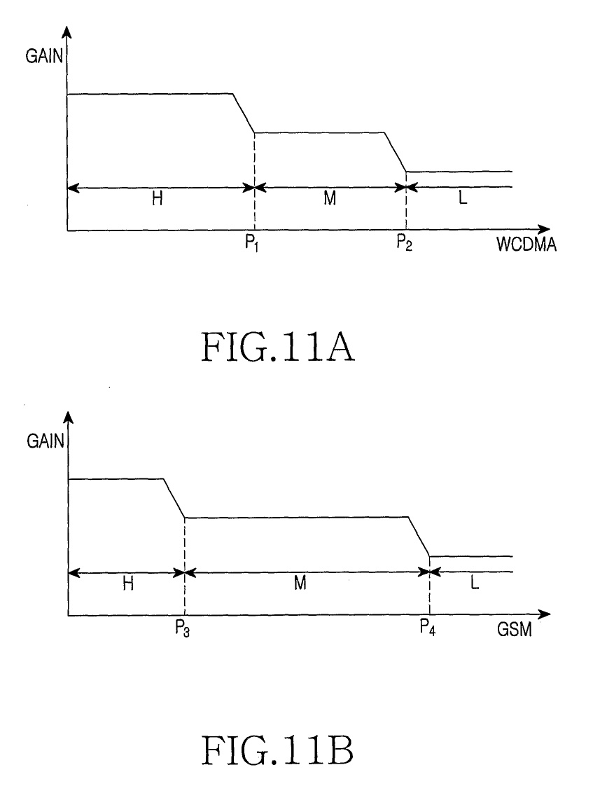

A method in which the WCDMA/PCS1900 combined receiver 622 and the WCDMA/GSM850 combined receiver 623 control the LNA gain to the gain corresponding to the WCDMA and the gain corresponding to the GSM, respectively, is shown in FIGS. 11A and 11B. Referring to FIGS. 11A and 11B, when a WCDMA signal is received, the WCDMA/PCS1900 combined receiver 622 and the WCDMA/GSM850 combined receiver 623 control the LNA gain by three levels based on reception strengths P1 and P2 of the WCDMA signal as shown in FIG. 11A. When a GSM signal is received, the WCDMA/PCS1900 combined receiver 622 and the WCDMA/GSM850 combined receiver 623 control the LNA gain by three levels based on reception strengths P3 and P4 of the GSM signal as shown in FIG. 11B. The reception strengths P1, P2, P3 and P4 can vary according to a modem algorithm.

The signal low-noise-amplified by the receivers 621 to 628 for modes and bands is input to the first mixer 680 or the second miser 690, which is a wideband mixer.

The controller 982 controls the first local frequency L01 provided to the first mixer 680 and the second local frequency L02 provided to the second mixer 690 to local frequencies corresponding to corresponding reception modes and bands. Accordingly, the first mixer 680 down converts a signal input from one of the WCDMA2000 receiver 621, WCDMA/PCS1900 combined receiver 622 and WCDMA/GSM850 combined receiver 623 corresponding to the main band using the first local frequency L01. The second mixer 690 down converts a signal input from one of the DCS1800 receiver 624, GSM900 receiver 625 and WCDMA diversity receivers 626 to 628 corresponding to the sub-band using the second local frequency L02.

The main band signal down converted by the first mixer 680 is input to the first baseband processing unit 984, and the first baseband processing unit 984 outputs the down converted main band signal as the first baseband signal in response to a control of the controller 982. The sub-band signal down converted by the second mixer 690 is input to the second baseband processing unit 986, and the second baseband processing unit 986 outputs the down converted sub-band signal as the second baseband signal in response to a control of the controller 982.

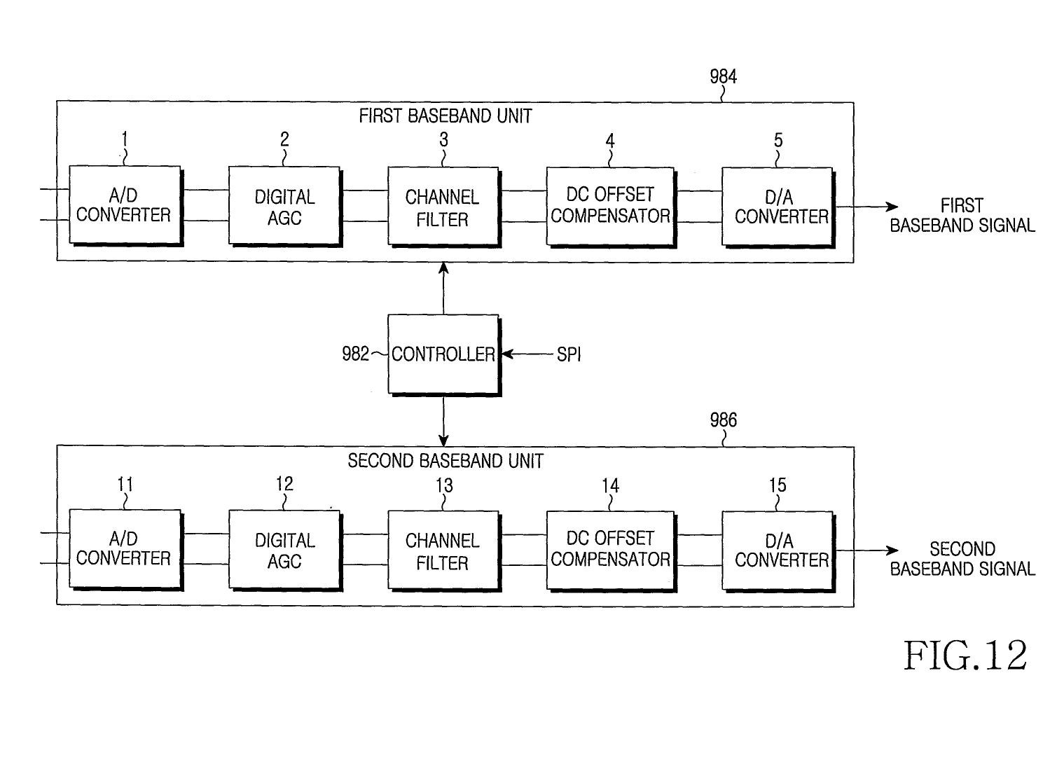

A block diagram illustrating a baseband signal processing operation of the first and second baseband processing units 984 and 986 is shown in FIG. 12. FIG. 12 is a block diagram illustrating the baseband signal processing operation of the multimode/multiband mobile station according to the preferred second embodiment of the present invention.

Referring to FIG. 12, the first baseband processing unit 984 includes an A/D converter 1, a digital automatic gain controller (AGC) 2, a channel filter 3, a DC offset compensator 4 and a D/A converter 5.

The A/D converter 1 receives the main band signal down converted by the first mixer 680 and converts the down converted main band signal to a digital signal. The digital AGC 2 controls a gain of the converted main band digital signal. The channel filter 3 may be a low pass filter (LPF), receiving the main band digital signal and filtering it to pass only a corresponding channel signal. The DC offset compensator 4 compensates for a DC offset of the filtered channel signal. The D/A converter 5 converts the DC-offset-compensated channel signal to an analog signal and outputs the converted analog signal as the first baseband signal.

According to the preferred second embodiment of the present invention, the main band signal can be the WCDMA2000, WCDMA1900, PCS1900, WCDMA850 or GSM850 band, and the controller 982 controls the first baseband processing unit 984 in response to the SPI signal received from the modem controller 991. Accordingly, each of the A/D converter 1, digital AGC 2, channel filter 3, DC offset compensator 4 and D/A converter 5 of the first baseband processing unit 984 operates with changing its characteristic according to a reception band characteristic under the control of the controller 982.

For example, when the reception band is the GSM850 band, each of the A/D converter 1, digital AGC 2, channel filter 3, DC offset compensator 4 and D/A converter 5 of the first baseband processing unit 984 operates according to a GSM850 band characteristic under the control of the controller 982. When the reception band is the WCDMA850 band, each of the A/D converter 1, digital AGC 2, channel filter 3, DC offset compensator 4 and D/A converter 5 of the first baseband processing unit 984 operates according to a WCDMA850 band characteristic under the control of the controller 982.

The second baseband processing unit 986 operates in a method similar to the first baseband processing unit 984 and the sub-band signal, i.e., a DCS1800, GSM900, WCDMA2000(D), WCDMA1900(D) or WCDMA850(D) band signal, as the second baseband signal.

Since the first baseband processing unit 984 processes the WCDMA2000, WCDMA1900, PCS1900, WCDMA850 or GSM850 band, the first baseband signal output from the first baseband processing unit 984 can be a WCDMA signal or a GSM signal.

Also, since the second baseband processing unit 986 processes the DCS1800, GSM900, WCDMA2000(D), WCDMA1900(D) or WCDMA850(D) band, the second baseband signal output from the second baseband processing unit 986 can be a GSM signal or a WCDMA diversity signal.

The baseband processing unit 980 outputs the first and second baseband signals to the modem module 990 by classifying them into the WCDMA baseband signal, GSM baseband signal and WCDMA diversity signal.

Referring back to FIG. 9, the modem module 990 receives a baseband signal corresponding to the WCDMA through an I1Q1 path and receives a baseband signal corresponding to the GSM or WCDMA diversity through an I2Q2 path.

Thus, if the first baseband signal output from the first baseband processing unit 984 is a WCDMA signal, the baseband processing unit 980 outputs the first baseband signal to the I1Q1 path, and if the first baseband signal is a GSM signal, the baseband processing unit 980 outputs the GSM baseband signal to the I2Q2 path through the multiplexer 988.

The baseband processing unit 980 also outputs the second baseband signal (GSM or WCDMA diversity signal) output from the second baseband processing unit 986 to the I2Q2 path through the multiplexer 988.

The multiplexer 988 outputs the GSM baseband signal output from the first baseband processing unit 984 or the GSM or WCDMA diversity baseband signal output from the second baseband processing unit 986 to the I2Q2 path.

A WCDMA modem 992 of the modem module 990 demodulates the WCDMA baseband signal received through the I1Q1 path.

A demultiplexer 993 of the modem module 990 receives the GSM or WCDMA diversity baseband signal through the I2Q2 path, outputs the GSM baseband signal to a GSM modem 94 if the GSM baseband signal is received, and outputs the WCDMA diversity baseband signal to a WCDMA diversity modem 998 if the WCDMA diversity baseband signal is received.

The GSM modem 994 demodulates the received GSM baseband signal. The WCDMA diversity modem 998 demodulates the received WCDMA diversity baseband signal.

While the invention has been shown and described with reference to detailed embodiments thereof, various changes may be made therein without departing from the scope of the present invention. For example, while an example in which a combined receiver receiving a WCDMA1900 MHz signal and a PCS1900 MHz signal together and a combined receiver receiving a WCDMA850 MHz signal and a GSM850 MHz signal together are used has been described in a preferred embodiment of the invention, signals of the same frequency band for different services, i.e., different wireless interface standards, in the invention are not limited to the specific signals described above. Therefore, the scope of the invention is defined not by the detailed description of the invention but by the appended claims and details.

As described above, in a multimode/multiband mobile station according to an embodiment of the present invention, power consumption of software-defined radio (SDR) processing components can be reduced without requiring a high processing rate of digital intermediate frequency (DIF) receiver components, and a sampling rate at an intermediate frequency (IF) can be lowered with maintaining a digital signal processing (DSP) function at an IF level.

For a multimode/multiband mobile station according to an embodiment of the present invention, it is possible to design a broadband image rejection (IR) mixer at an RF analog front end of each receiver to satisfy multiple frequency bands with low current consumption. In addition, there is a possibility of configuring a digital IF filter, and a digital IF section can operate at a relatively low sampling rate, thereby reducing the current consumption.

In a multimode/multiband mobile station according to an embodiment of the present invention, the number of receivers can be reduced by using one combined receiver of the same frequency band for different services. In addition, the multimode/multiband mobile station can use a duplexer of the conventional frequency division duplex (FDD) technique (e.g., WCDMA) in a time division duplex (TDD) technique (e.g., GSM850 or PCS1900).

A multimode/multiband mobile station according to an embodiment of the present invention can be implemented with less mixers by using combined mixers, one for receivers of a main reception band and the other for receivers of a sub reception band.

What is claimed is:

1. A multimode/multiband mobile station for wireless networks operating based on various wireless interface standards, the mobile station comprising:
a plurality of low-noise amplifiers (LNAs), each matched to a selected frequency band; and
a near-zero intermediate frequency (NZIF) broadband image rejection (IR) mixer for receiving an amplified radio frequency (RF) signal from one amplifier selected among the plurality of LNAs and generating a first analog intermediate frequency (IF) signal by down converting the amplified RF signal.

2. The mobile station of claim 1, further comprising a switch for coupling the selected LNA with the NZIF broadband IR mixer.

3. The mobile station of claim 2, wherein the switch selects the selected LNA according to a first wireless interface standard by which the mobile station operates.

4. The mobile station of claims 3, further comprising a programmable frequency controlled oscillator for supplying an oscillator reference signal of a selectable frequency to the NZIF broadband IR mixer.

5. The mobile station of claim 4, further comprising a first reconfigurable band pass filter (BPF) for filtering the first analog IF signal output from the NZIF broadband IR mixer.

6. The mobile station of claim 5, wherein the first reconfigurable BPF filters the first analog IF signal according to the first wireless interface standard by which the mobile station operates.

7. The mobile station of claim 6, wherein the first reconfigurable BPF removes useless frequencies from the first analog IF signal.

8. The mobile station of claims 7, further comprising a programmable variable gain amplifier (VGA) for amplifying a first filtered analog IF signal output from the first reconfigurable BPF.

9. The mobile station of claim 8, further comprising a second reconfigurable BPF for filtering the a first filtered analog IF signal amplified by the programmable VGA.

10. The mobile station of claim 9, wherein the second reconfigurable BPF is an anti-alias filter.

11. The mobile station of claim 10, further comprising an analog/digital converter (ADC) for converting a second filtered IF signal output from the second reconfigurable BPF to a digital IF signal.

12. The mobile station of claim 11, wherein the programmable VGA amplifies the first filtered analog IF signal based on an operating range of the ADC.

13. The mobile station of claims 12, further comprising a reconfigurable digital IF processing block.

14. An operating method of a multimode/multiband mobile station for wireless networks operating based on various wireless interface standards, the method comprising the steps of:
amplifying a receive radio frequency (RF) signal by selecting one of a plurality of low-noise amplifiers (LNAs), and matching each of the plurality of LNAs to a selected frequency band; and
generating, by a near-zero intermediate frequency (NZIF) broadband image rejection (IR) mixer, a first analog intermediate frequency (IF) signal by down converting the RF signal amplified by the selected LNA.

15. The method of claim 14, further comprising the step of coupling the selected LNA with the NZIF broadband IR mixer using a switch.

16. The method of claim 15, wherein the switch selects the selected LNA according to a first wireless interface standard by which the multimode/multiband mobile station operates.

17. The method of claims 16, wherein the NZIF broadband IR mixer receives an oscillator reference signal of a selectable frequency from a programmable frequency controlled oscillator.

18. The method of claim 17, further comprising the step of filtering the first analog IF signal output from the NZIF broadband IR mixer in a first reconfigurable band pass filter (BPF).

19. The method of claim 18, wherein the first reconfigurable BPF filters the first analog IF signal according to the first wireless interface standard by which the multimode/multiband mobile station operates.

20. The method of claim 19, wherein the first reconfigurable BPF removes useless frequencies from the first analog IF signal.

21. A multimode/multiband mobile station comprising:
a transmission module for transmitting multimode/multiband signals through transmitters; and
a reception module for receiving signals corresponding to the same frequency bands among the multiple modes and multiple bands through combined receivers, which receive at least one radio signal of the same frequency band for different services together, and receiving signals not corresponding to the same frequency bands through receivers for different frequency bands.

22. The mobile station of claim 21, wherein each of the combined receivers comprises a low noise amplifier (LNA) amplifying a reception signal of the same frequency band for difference services.

23. The mobile station of claim 21, further comprising a duplex module for dividing transmission/reception signals of a frequency division duplex (FDD) technique and a time division duplex (TDD) technique.

24. The mobile station of claims 21, further comprising a duplex for receiving a GSM signal and transmitting the received GSM signal to a GSM receiver.

25. The mobile station of claim 21, wherein the duplex further comprising a duplex for receiving one of a GSM signal or WCDMA signal of a common band and transmitting the received signal to a WCDMS/GSM combined receiver.

26. The mobile station of claim 21, wherein the multiple modes and multiple bands comprise a WCDMA2000 MHz band, a WCDMA1900 MHz band, a WCDMA850 MHz band, a GSM850 MHz band, a GSM900 MHz band, a DCS1800 MHz band and a PCS1900 MHz band.

27. The mobile station of claim 21, wherein the transmission module comprise at least one of a WCDMA2000 MHz transmitter for transmitting a signal of the WCDMA2000 MHz band, a WCDMA1900 MHz transmitter for transmitting a signal of the WCDMA1900 MHz band, a WCDMA850 MHz transmitter for transmitting a signal of the WCDMA850 MHz band, a DCS1800/PCS1900 transmitter for transmitting signals of the DCS1800 MHz and PCS1900 MHz bands, and a GSM850/GSM900 transmitter for transmitting signals of the GSM850 MHz and GSM900 MHz bands.

28. The mobile station of claims 21, wherein the receivers for different frequency bands comprise at least one of a WCDMA2000 MHz receiver for receiving a signal of the WCDMA2000 MHz band, a DCS1800 receiver for receiving a signal of the DCS1800 MHz band, and a GSM900 receiver for receiving a signal of the GSM900 MHz band.

29. The mobile station of claim 21, wherein each of the combined receivers comprises one of a WCDMA/PCS1900 receiver for receiving a signal of the WCDMA1900 MHz band and a signal of the PCS1900 MHz band together and a WCDMA/GSM850 receiver for receiving a signal of the WCDMA850 MHz band and a signal of the GSM850 MHz band together.

30. The mobile station of claim 21, further comprising:
a first mixer for converting a signal of a high frequency band received by receivers receiving a main reception band, which is a band with a high usage rate in a certain area, among the multiple modes and multiple bands to a signal of a low frequency band; and
a second mixer for converting a signal of a high frequency band received by receivers receiving a sub reception band, which has a low usage rate in a certain area, among the multiple modes and multiple bands for multiple communication services to a signal of a low frequency band.

31. The mobile station of claim 30, wherein the sub reception band comprises a diversity band.

32. A multimode/multiband mobile station comprising:
a switch module for performing a switching operation for selecting a mode and band to be received among multiple modes and multiple bands based on a predetermined control;
receivers, each for receiving its own mode/band signal among multimode/multiband signals based on the switching operation;
mixers, each for down converting the received signal using a local frequency corresponding to the mode and band to be received;
a baseband processing module for controlling a receiver corresponding to the mode and band to be received among the receivers based on a predetermined control, baseband-processing the down converted reception signal, and outputting a baseband signal by classifying the baseband signal for each mode; and
a modem module for outputting a control signal for receiving a signal of the mode and band to be received, controlling the local frequency to a local frequency corresponding to the mode and band to be received, and demodulating the baseband signal for each mode through a modem for each mode.

33. The mobile station of claim 32, wherein the multiple modes and multiple bands comprise bands of a WCDMA mode and bands of a GSM mode.

34. The mobile station of claim 32, wherein the receivers comprise:
WCDMA receivers for receiving bands of the WCDMA mode;
GSM receivers for receiving bands of the GSM mode; and
WCDMA/GSM combined receivers for receiving common bands of the WCDMA and GSM modes.

35. The mobile station of claim 33, wherein the switch module comprises:
a first antenna switch for performing switching for selecting a reception mode and frequency band to be received among the bands of the WCDMA mode and the bands of the GSM mode based on a predetermined control;
a band selection switch for selecting a frequency band of the GSM mode when the reception mode is selected as the GSM mode; and
a second antenna switch for selecting whether WCDMA diversity reception is performed when the reception mode is selected as the WCDMA mode.

36. The mobile station of claims 33, wherein the mixers comprise:
a first mixer for down converting a signal received by receivers receiving the bands of the WCDMA mode and the common bands of the WCDMA and GSM modes among the multiple modes and multiple bands; and
a second mixer for down converting a signal received by receivers receiving the bands of the GSM mode and WCDMA diversity bands among the multiple modes and multiple bands

37. The mobile station of claim 36, wherein the baseband processing module comprises:
a first baseband processing unit for baseband-processing each band signal of the WCDMA mode and each band signal of the WCDMA and GSM modes down-converted by the first mixer based on a predetermined control;
a second baseband processing unit for baseband-processing each band signal of the GSM mode and each WCDMA diversity band signal down-converted by the second mixer based on a predetermined control; and
a controller for controlling processing operations of the first and second baseband processing units according to a reception mode and band characteristic.

38. The mobile station of claim 37, further comprising:
a first path for transferring a WCDMA signal among baseband signals output from the first and second baseband processing units to the modem module; and
a second path for transferring a GSM signal or a WCDMA diversity signal among the baseband signals output from the first and second baseband processing units to the modem module.

39. The mobile station of claims 37, wherein the modem module comprises:
a WCDMA modem for demodulating the WCDMA baseband signal output from the baseband processing module;
a GSM modem for demodulating the GSM baseband signal output from the baseband processing module;
a WCDMA diversity modem for demodulating the WCDMA diversity baseband signal output from the baseband processing module; and
a modem controller for outputting a control signal to receive a signal of a desired mode and band among the multiple modes and multiple bands and controlling the local frequency to a local frequency corresponding to the mode and band to be received.

40. The mobile station of claim 39, wherein the control signal to receive a signal of a desired mode and band among the multiple modes and multiple bands comprises:
a switch control signal for controlling the switch module; and
an SPI signal for controlling the baseband processing module.

41. The mobile station of claim 40, wherein baseband processing module controls an operation of a receiver corresponding to a mode and band to be received among the receivers based on the SPI signal, controls a low noise amplification (LNA) gain of a WCDMA/GSM combined receiver to an LNA gain corresponding to the mode and band to be received when the receiver corresponding to the mode and band to be received is for a WCDMA/GSM combined band, and controls processing operations of the first and second baseband processing units.

42. The mobile station of claim 39, wherein the switch control signal for controlling the switch module comprises:
a first switch control signal for selecting a reception mode and frequency band to be received among the bands of the WCDMA mode and the bands of the GSM mode;
a second switch control signal for selecting a frequency band of the GSM mode when the reception mode is selected as the GSM mode; and
a third switch control signal for selecting whether the WCDMA diversity reception is performed.
